(19) United States
(12) Patent Application Publication
(10) Pub. No.: US 2024/0275208 A1
(43) Pub. Date: Aug. 15, 2024

(54) WIRELESS POWER AND DATA TRANSFER USING A SINGLE PAIR OF COILS

(71) Applicant: Aston Vision Sciences Ltd., Birmingham (GB)

(72) Inventors: Karl Obszanski, Birmingham (GB); Karina Obszanska, Birmingham (GB); Cheah Moey, Birmingham (GB); Masoud Kazemi, Birmingham (GB)

(73) Assignee: Aston Vision Sciences Ltd., Birmingham (GB)

(21) Appl. No.: 18/569,968

(22) PCT Filed: Jun. 20, 2022
(86) PCT No.: PCT/GB22/51569

§ 371 Date: Dec. 13, 2023

(30) Foreign Application Priority Data
Jun. 21, 2021 (GB) 2108856.2
Nov. 5, 2021 (GB) 2115918.1

(51) Int. Cl. H02J 50/10; H02J 50/80; H04B 5/26; H04B 5/79

(52) U.S. Cl. CPC H02J 50/10; H02J 50/80; H04B 5/266; H04B 5/79

(57) ABSTRACT

A wireless power and data transfer system (1000) comprising: a single pair of inductive coils including: a primary coil (1009) arranged to transmit a power signal having a first frequency; and a secondary coil (1011) arranged to receive the power signal from the primary coil by wireless induction; a primary side circuit (1001) arranged to: generate a modulated first control signal by modulating a first control signal on a first carrier signal; and superimpose the modulated first control signal onto the power signal at the primary coil (1009), the first carrier signal having a second frequency different to the first frequency; and a secondary side circuit (1003) arranged to: generate a modulated second control signal by modulating a second control signal on a second carrier signal; and superimpose the modulated second control signal onto the power signal at the secondary coil (1011), the second carrier signal having a third frequency different to the first frequency and second frequency.

The present disclosure relates to illumination devices. In particular, but not exclusively, the present disclosure relates to ophthalmic devices for illuminating a patient's eye. In particular, but not exclusively, the present disclosure relates to devices for projection of different illumination patterns onto and into a patient's eye, and methods of projecting a plurality of illumination patterns. The present disclosure also relates to a wireless power transfer system and a method of wireless power and data transfer.

Measuring the shape of the anterior surface of the cornea (to assess astigmatism, for example) is typically carried out using a topographer which projects a series of black and white concentric rings onto the cornea by back-lighting a Placido disc. The reflection of the rings is observed by an ophthalmologist through a hole at the centre of the disc, or an image is captured through the hole, and transferred to a computer for analysis. A topographer can also be used to assess non-invasive tear film break-up to diagnose dry eye.

A number of topogahpers and tear scopes are known such as the Keeler Tearscope™ and the commercially available Oculus™ Keratograph and Easy Tear View™ (which superseded the Keeler Tearscope™ and works on the same principles).

The Keeler Tearscope™ is a hand-held device comprising a hemispherical cup mounted on a handle and back-lit by a cold cathode ring light source. The surface of the cup is marked with a grid pattern which is projected onto the patient's eye. In use, the Tearscope™ is held as close to the surface of the eye as possible so that the area illuminated can be maximized. Due to the bright illumination, this is often uncomfortable for the patient. The eye is observed through an observation hole at the centre of the hemispherical cup.

The Oculus™ Keratograph is a table mounted device having a larger hemispherical cup marked with black concentric rings back lit by a white light source. The patient rests their chin on a chin strap of a head support and the concentric rings are reflected from the patient's eye and observed by a camera mounted at the centre of the hemispherical cup.

The back lighting of the concentric rings is very bright to compensate for the spacing of the patient's head and eye from the marked hemispherical cup. This brightness can be uncomfortable for the patient. Furthermore, the hemispherical cup has to be made large (hence the requirement for desk mounting) in order to ensure a large area of the cornea is illuminated due to the spacing between the hemispherical cup and the eye.

EP 3 773 144 discloses an ophthalmic device that can replicate the functionality of a topographer. The device comprises at least one linear array of a plurality of light sources. The linear array is rotationally mounted about a central axis on a mounting body which may contain a motor. The linear array has an inner end and an outer end, and the inner end is mounted closer to the central axis and the mounting body than the outer end. As the array is rotated, it forms a series of concentric and conical rings of light that can be projected onto an eye.

Various candidates have been considered for providing power and control communications to electronic components, such as light sources, mounted on rotating elements. One possible technology for transferring power is using slip rings. However, slip rings generate noise that is not appropriate for some applications. Furthermore, slip rings need regular maintenance or replacement due to frictional wear. As another solution, batteries have been used. However, this is not suitable when the rotating part needs a high range of power and it can make balancing the rotating part difficult. When using batteries or slip rings, separate data communication systems are required.

Wireless power transfer systems have been considered for transferring power to rotating elements. Various wireless power transfer methods are known. For example, near field wireless power transfer may take place by inductive coupling or capacitive coupling. Such techniques allow the transmission of power only from a power source to a load, but not for the transmission of data in any direction. Various wireless communication techniques are also known, such as Wi-Fi, Bluetooth, cellular communications and Zigbee. These allow transmission of data but not power.

Techniques such as Radio Frequency Identification (RFID) and Near Field Communications (NFC) allow for both transmission of data and power. However, these are passive communication methods, and the data transmission is unidirectional or half duplex. Other candidate technologies present power transfer and full duplex data communication methods. However, these only allow transfer of data in specified windows, and/or they use two or more pairs of coils for power and data transfer.

According to a first aspect of the invention, there is provided wireless power and data transfer system comprising: a single pair of inductive coils including: a primary coil arranged to transmit a power signal having a first frequency; and a secondary coil arranged to receive the power signal from the primary coil by wireless induction; a primary side circuit arranged to: generate a modulated first control signal by modulating a first control signal on a first carrier signal; and superimpose the modulated first control signal onto the power signal at the primary coil, the first carrier signal having a second frequency different to the first frequency; and a secondary side circuit arranged to: generate a modulated second control signal by modulating a second control signal on a second carrier signal; and superimpose the modulated second control signal onto the power signal at the secondary coil, the second carrier signal having a third frequency different to the first frequency and second frequency.

The wireless power transfer system allows for continuous, real-time bidirectional data (full duplex) communication between a primary side and a secondary side, whilst also allowing for concurrent power transfer from the primary side to the secondary side over one pair of coils. The transfer of power is continuous and uninterrupted, even whilst communication is ongoing and under stationary or rotational conditions. Furthermore, the system is simple and low cost to implement due to the low number of components. The system is long lasting as there are no frictional parts or connections between the primary and secondary circuits.

The primary side circuit may comprise a primary filter arranged to isolate the modulated second control signal from the power signal and the modulated first control signal at the primary coil. The secondary side circuit may comprise a secondary filter arranged to separate the modulated first control signal form the power signal and the modulated second control signal at the secondary coil. The primary filter and/or the secondary filter may comprise inductive transformers with LC filters.

Each of the first control signal and the second control signal may include at least one data channel for transferring data between the primary side circuit and the secondary side circuit. At least one of the first control signal and the second control signal may include two or more data channels. Advantages of the multi-channel, bi-directional operability may include enhanced monitoring and output voltage feedback control, improved load detection, enhanced data transfer rate and power transfer efficiency.

The two or more data channels may be combined into a control signal, prior to being superimposed on the power signal.

One of the first control signal and the second control signal may encode a clock component and a data component on separate channels, and the other of the first control signal and the second control signal encodes a different data component. The clock component allows for synchronization between the primary side and the secondary side.

The control signal that encodes a clock component may comprise a logic signal able to adopt a plurality of different logic values, each logic value corresponding to a unique combination of the values of the data component and the clock component.

The data component and the clock component may each comprise a binary logic signal having a low value and a high value, and the control signal that encodes a clock component and a data component may adopt one of four possible logic values derived from the logic value of the data component and the clock component.

The primary side circuit may comprise a primary modulation module arranged to modulate the first control signal to generate the modulated first control signal. The secondary side circuit may comprise a second modulation module arranged to modulate the second control signal to generate the modulated second control signal.

The control signals may be modulated by amplitude modulation, optionally using amplitude-shift keying modulation or any other type of modulations.

The first frequency may be lower than the second frequency and the third frequency.

The amplitude of the power signal may be greater than the amplitude of the modulated first control signal and the modulated second control signal.

For example, primary instructions may be, but not limited to, SCL and SDA lines of an I2C communication protocol and secondary instructions may be an acknowledge signal, confirming successful transmission of at least a portion of the first control signal.

The primary side circuit may comprise a primary inductive transformer to superimpose the modulated first control signal onto the power signal at the primary side. The secondary side circuit may comprise a secondary inductive transformer to superimpose the modulated second control signal onto the power signal at the secondary side.

The primary side circuit may comprise a primary processor arranged to generate the first control signal and receive the second control signal. The secondary side circuit comprises a secondary processor arranged to generate the second control signal and receive the first control signal.

The first control signal may comprise instructions sent from the primary processor to the secondary processor, and the second control signal may comprise instructions sent from the secondary processor to the primary processor. For example, primary instructions may be, but not limited to, SCL and SDA lines of an I2C communication protocol and secondary instructions may be an acknowledge signal, confirming successful transmission of at least a portion of the first control signal. The roles of the primary processor and secondary processor may be reversed, and the secondary side can be capable of receiving an acknowledge signal to allow for data/instructions to be sent from the secondary to the primary.

The wireless power and data transfer system may comprise a first counter arranged to detect a start of a communication window the communication window being a fixed number of bits, n, in size; a second counter arranged to count the number of bits received from the start of the communication window or continuing counting on from the previous n-bit window, up to the fixed number of bits; and a third counter arranged to detect the window for the acknowledge signal. Alternatively, digital components such as logic gates may be used as substitutes to counters. In systems where other types of communication protocol (for example CAN bus, SPI, UART or others) are used, different methods of reading the sent data may apply.

The wireless power and data transfer system may comprise a primary logic inverter gate to invert the output logic of the primary processor. Additionally or alternatively, the wireless power and data transfer system may comprise a secondary logic inverter gate to invert the output logic of the secondary processor. Inverting the output of the processors may help reduce power consumption by making the default high output a low signal.

The secondary side may work without a logic inverter gate for returning logic of the signals to correct logics as the signals coming from the primary side can be interpreted through logic gates. Similarly, the primary side may work without a logic inverter gate for returning logic of signals coming from the secondary to correct logics as the signals coming from the secondary side can be interpreted through logic gates.

The primary and secondary coils may be arranged stationary with respect to each other and to an external reference. Alternatively, both or one of the primary coil and secondary coil may be arranged to rotate about its central axis.

The primary coil and secondary coil may or may not each comprise an aperture arranged in the coil. This aperture allows an inductively beneficial material to be provided through both primary and secondary coils to boost the inductive signal, and/or allows for passing wires or cables thereby allowing for direct connection between primary and secondary sides components as necessary.

The wireless power and data transfer system may comprise a core extending through the apertures between the primary coil and the secondary coil

The core may be hollow, thereby allowing components or cabling to be passed through the centre of the coils.

The core may be a ferrite core.

According to an second aspect of the invention, there is provided a method of wireless power and data transfer, over a single pair of inductive coils, the method comprising: transmitting a power signal from a primary coil to a secondary coil by wireless induction; generating a modulated first control signal by modulating a first control signal on a first carrier signal; generating a modulated second control signal by modulating a second control signal on a second carrier signal; superimposing the modulated first control signal onto the power signal at the primary coil; and superimposing the modulated second control signal onto the power signal at the secondary coil, wherein the power signal has a first frequency, the first carrier signal has a second frequency different to the first frequency and the second carrier signal has a third frequency different to the first frequency and the second frequency.

The method allows for continuous, real-time bidirectional data (full duplex) communication between a primary side and a secondary side, whilst also allowing for concurrent power transfer from the primary side to the secondary side over one pair of coils. The transfer of power is continuous and uninterrupted, even whilst communication is ongoing, and under stationary or rotational conditions. Furthermore, the method is simple and low cost to implement due to the low number of components required. The system is also long lasting as there are no frictional parts or connections between the primary and secondary circuits.

The method may comprise: filtering the signal induced at the secondary coil to isolate the modulated first control signal from the power signal and the modulated second control signal; and/or filtering the signal induced at the primary coil to isolate the modulated second from the power signal and the modulated first control signal control signal.

Each of the first control signal and the second control signal may include at least one data channel for transferring data between the primary side circuit and the secondary side circuit. At least one of the first control signal and the second control signal may include two or more data channels. Advantages of the multi-channel, bi-directional operability may include enhanced monitoring and output voltage feedback control, improved load detection, enhanced data transfer rate and power transfer efficiency.

The method may comprise: combining the two or more data channels into a control signal, prior to being superimposed on the power signal.

One of the first control signal and the second control signal may encode a clock component and a data component on separate channels, and the other of the first control signal and the second control signal may encode a different data component. The clock component allows for synchronization between the primary side and the secondary side.

The control signal that encodes a clock component comprises a logic signal may be able to adopt a plurality of different logic values, each logic value corresponding to a unique combination of the values of the data component and the clock component.

The data component and the clock component may each comprise a binary logic signal having a low value and a high value, and the modulated control signal that encodes a clock component and a data component may adopt one of four possible logic values derived from the logic value of the data component and the clock component.

The first frequency may be lower than the second frequency and the third frequency.

The amplitude of the power signal may be greater than the amplitude of the modulated first control signal and the modulated second control signal.

The first control signal may comprise instructions sent from the primary side to the secondary side, and the second control signal comprises instructions sent from the secondary side to the primary side.

According to a third aspect of the invention, there is provided an electrical connector having an enclosure housing one of the primary coil and secondary coil of the wireless power and data transfer system of the first aspect, wherein the connector is releasably connectable to a device including the other of the primary coil and secondary coil.

The connector provides a means to form an electrical and data connection using wireless power transfer. This may be useful, for example, in environments where usual connectors requiring hard connection may be unsuitable.

The device may comprise a second enclosure housing the primary coil and secondary coil.

The connector may be releasably connectable to the device using a nut and bolt extending through the centre of the primary coil and secondary coil.

The bolt may be a ferrite material.

The connector may be releasably connectable by means of a protruding core enclosed within either the primary or secondary coil which has a corresponding profile in which to engage with the other coil. The protruding core may be a ferrite core.

The connector and/or device may comprise magnets for releasably connecting the connector and the device.

The connector may comprise a clamping mechanism arranged to hold the connector and device together.

The connector and device may have corresponding screw threads for releasably connecting the device and connector.

One of the connector and the device may comprise a locating projection and the other of the connector or device may comprise a corresponding recess, to locate the connector and device relative to each other.

One of the primary coil and secondary coil housed in the enclosure may be connected to the corresponding primary or secondary circuit by a cable extending out of the enclosure.

According to a fourth aspect of the invention, there is provided an electrical connector system comprising: a first connector having an enclosure housing the primary coil of the wireless power and data transfer system of the first aspect; and a second connector having an enclosure housing the secondary coil of the wireless power and data transfer system of the first aspect.

According to a fifth aspect of the invention, there is provided a wind turbine comprising a rotor including turbine blades and a stationary body, wherein the rotor includes a control system having a rotor controller and one or more of: sensors; and mechanisms for controlling the angle of the turbine blades; and wherein the wind turbine further comprises the wireless power and data transfer system of the first aspect for providing power from the body to the rotor control system, and for data communications between the body and the rotor control system.

Use of the wireless power and data transfer system increases the lifetime of components in the wind turbine.

The primary coil may be provided on the stationary body and the secondary coil may be provided on the rotor.

According to a sixth aspect, there is provided an illumination device for projecting a plurality of different illumination patterns onto and into an eye of a patient, the illumination device comprising: a support having a central axis and comprising an forward facing surface; and two or more sets of light emitting elements mounted on the support, facing the same direction as the forward facing surface, each set of light emitting elements comprising one or more light emitting element, wherein each set of light emitting elements is arranged to emit one or more different patterns of light based on selectively switching of the light emitting elements and selectively rotating the support and different sets of light emitting elements are arranged to emit different patterns.

By providing a device having a plurality of different sets of light emitting elements, the device can be used for a wide range of different tests and measurements. The device allows for observation of both the anterior and posterior of the eye. By selecting different combinations of light emitting elements to switch on and off during rotation, different regions of the eye can be illuminated for particular examinations.

The light emitting elements may be mounted on the forward facing surface.

Alternatively, the light emitting elements may be mounted behind the support. Openings may be formed in the support, aligned with the light emitting elements. The light emitting elements may be mounted such that they rotate with the support.

The forward facing surface faces towards a patient, in use.

A first set of light emitting elements may have an array of light emitting elements. The array may be arranged in a first string extending radially outwards from the central axis.

The illumination device may comprise a second set of light emitting elements having an array of light emitting elements. The array may be arranged in a second string extending radially outwards from the central axis.

The second set may be spaced from the first set around the central axis.

The first string, and optionally the second string, may follow a non-linear path. The first string, and optionally the second string, may follow an arc with respect to the forward facing surface of the support.

Alternatively, the first string, and optionally the second string, may follow a linear path with respect to the forward facing surface of the support.

The second string may follow the same path as the first string, at a different position around the forward facing surface.

The support may be frustoconical in shape, with an open base. The forward facing surface may be the inner surface of the frustoconical support.

A frustoconical support may have a proximal end having first diameter, and a distal end having second diameter larger than the first diameter, the distal end facing a patient, in use. The distal end may be open.

At least one set of light emitting elements may comprise a single light emitting element.

The single light emitting element may comprise one of: a point light source; or an elongate light emitting element extending in a radial direction with respect to the central axis.

At least one set of light emitting elements may comprise: an array of light emitting elements; and a shaping lens arranged to focus the light emitted from one of the light emitting elements into a desired projection shape. For example, the projection may be a rectangular slit or a circle or ellipse.

The light emitting elements within at least one of the sets of light emitting elements may be the same colour.

The light emitting elements within at least one of the sets of light emitting elements may be different colours.

The light emitting elements may emit one or more of the following: white light; infrared light; ultraviolet light; blue light; red light; green light or the light emitting elements may emit a mixture of light, such as a RGB mixture.

The illumination device may comprise control circuitry arranged to control switching of the light emitting elements, at least part of the control circuitry arranged on the support.

The illumination device may comprise a body. The support may be mounted on and arranged to rotate with respect to the body.

The body may comprise connecting means arranged to detachably connect one or more accessories in front of the support.

The body may comprise a connector which is configured to engage with an existing instrument such as a chin rest to enable the illumination device to be removably fixed to the existing instrument.

The body may comprise wireless power transfer means arranged to transfer power and optionally data from the body to the support.

The support may have a viewing window along the axis, through which a patient's eye can be imaged.

The illumination device may comprise a camera for imaging a patient's eye through the viewing window. The camera may be configured to be stationary around the central axis.

The illumination device may comprise a lens between the camera and the viewing window, optionally wherein the lens comprises one of: a fixed focal lens; a manually adjustable mechanical lens which is configured to allow zoom and focal length adjustments; and a fluidic lens which is configured to allow for focal length adjustment and digital zoom.

The camera may be arranged to rotate about one or more axes extending perpendicular to the central axis, prior to capturing an image.

The light emitting elements may be mounted on flexible printed circuit board, and the flexible printed circuit board may be mounted on the forward facing surface.

According to a seventh aspect, there is provided an illumination device comprising: a body; a support mounted on the body, and arranged to rotate with respect to the body, about a central axis of the support; one or more light emitting elements provided on the support; a power source arranged to provide power to the light emitting elements, the power source being stationary with respect to the support, when the support is rotated; and a wireless power transfer system arranged to transfer power from the power source to the light emitting elements, the system comprising: a primary inductive coil mounted on the body and arranged to transmit a power signal from the power source, the primary coil being stationary with respect to the support, when the support is rotated; a secondary inductive coil mounted from the support and arranged to rotate with the support, the secondary coil arranged to receive the power signal.

The wireless power transfer system is simple to implement making the device low cost and simple to use. The wireless power transfer system has long life due to the lack of any frictional connections for wireless power transfer.

The illumination device may comprise an aperture arranged in the centre of the support and each inductive coil. This aperture allows an inductively beneficial material to be provided through both primary and secondary coils to boost the inductive signal, and/or allows for passing wires or cables thereby allowing for direct connection between primary and secondary sides components as necessary.

The illumination device may comprise a core extending through the apertures in the support and coils. The core may be hollow, forming a passage therethrough.

The illumination device may comprise one or more further components supported from the core, wherein a connection to the further components is provided through the passage.

The core may be a ferrite core.

The illumination device may further comprise: control circuitry mounted on the support, arranged to control operation of the light emitting elements, wherein the wireless power transfer system is arranged to transfer commands for controlling the light emitting elements concurrently with transferring power.

The power signal may have a first frequency. The illumination device may further comprise: a primary side circuit arranged to: generate a modulated first control signal by modulating a first control signal on a first carrier signal; and superimpose the modulated first control signal onto the power signal at the primary coil, the first carrier signal having a second frequency different to the first frequency; and a secondary side circuit arranged to: generate a modulated second control signal by modulating a second control signal on a second carrier signal; and superimpose the modulated second control signal onto the power signal at the secondary coil, the second carrier signal having a third frequency different to the first frequency and second frequency.

The wireless power transfer system allows for bidirectional data (full duplex) communication between the body and the support, whilst also allowing for concurrent power transfer from the power source to the support over one pair of coils. The transfer of power is continuous and uninterrupted, under stationary or rotational conditions, even whilst communication is ongoing. Furthermore, the system is simple and low cost to implement due to the low number of components. The system is also long lasting as there are no frictional parts or connections between the primary and secondary circuits.

The primary side circuit may comprise a primary filter arranged to isolate the modulated second control signal from the power signal and the modulated first control signal at the primary coil; and the secondary side circuit comprises a secondary filter arranged to separate the modulated first control signal from the power signal and the modulated second control signal at the secondary coil.

The wireless power transfer system may be able to send two or more data channels at the same time as power from each side using just one pair of coils. Advantages of the multi-channel, bi-directional operability may include enhanced monitoring and output voltage feedback control, improved load detection, enhanced data transfer rate and power transfer efficiency. The two or more data channels may be combined into a control signal, prior to being superimposed on the power signal.

One of the first control signal and the second control signal may encode a clock component and a data component as separate channels, and the other of the first control signal and the second control signal may encode a different data component. The clock component allows for synchronization between the primary side and the secondary side.

The control signal that encodes a clock component may comprise a logic signal able to adopt a plurality of different logic values, each logic value corresponding to a unique combination of the values of the data component and the clock component.

The data component and the clock component may each comprise a binary logic signal having a low value and a high value, such that the one of the first control signal and the second control signal that encodes a clock component and a data component adopts one of four possible logic values derived from the logic value of the data component and the clock component.

The first frequency may be lower than the second frequency and the third frequency.

The amplitude of the power signal may be greater than the amplitude of the modulated first control signal and the modulated second control signal.

The primary side circuit may comprise a primary inductive transformer to superimpose the modulated first control signal onto the power signal at the primary side. The secondary side circuit may comprise a secondary inductive transformer to superimpose the modulated second control signal onto the power signal at the secondary side.

The primary side circuit may comprise a primary processor arranged to generate the first control signal and receive the second control signal. The secondary side circuit may comprise a secondary processor arranged to generate the second control signal and receive the first control signal.

The first control signal may comprise the commands sent from the primary processor to the secondary processor, and the second control signal may comprise instructions sent from the secondary processor to the primary processor. For example, primary instructions may be, but not limited to, SCL and SDA lines of an I2C communication protocol and secondary instructions may be an acknowledge signal, confirming successful transmission of at least a portion of the first control signal. The roles of the primary processor and secondary processor may be reversed, and the secondary side can be capable of receiving an acknowledge signal to allow for data/instructions to be sent from the secondary to the primary.

The illumination device may comprise a first counter arranged to detect a start of a communication window, the communication window being a fixed number of bits, n, in size; a second counter arranged to count the number of bits received from the start of the communication window or continuing counting on from the previous n-bit window, up to the fixed number of bits; and a third counter arranged to detect the window for the acknowledge signal. Alternatively, digital components such as logic gates may be used as substitutes to counters. In systems where other types of communication protocol (for example CAN bus, SPI, UART or others) are used, different methods of reading the sent data may apply.

The support may be frustoconical in shape, and the light emitting elements may be arranged on an inner surface of the frustoconical support.

According to an eighth aspect, there is provided an illumination device comprising: an array of independently controllable light emitting elements; and a shaping lens arranged to focus light emitted by the light emitting elements into a desired shape; wherein the shaping lens includes a planar rear surface facing the array of light emitting elements and parallel to the array of light emitting elements, and an opposing front surface, spaced from the rear surface, the front surface being convex in shape.

The device is able to provide shaped projections for various uses. Furthermore, the direction in which the shape is projected can be easily controlled, allowing for more parts of a patient's eye to be easily examined.

In one example, the shape may be a rectangular slit. In this example, the device can replicate a slit lamp. In other examples, the shape may be circular, elliptical or any other shape.

The array may comprise a two-dimensional array.

The shaping lens may overlie the array and may be positioned centrally with respect to the array.

The illumination device may comprise a controller arranged to selectively switch the light emitting elements, such that a single element is on at a time.

Different light emitting elements may project the light (in the desired shape) in a different direction.

The area covered by the array of light emitting elements may be greater than the area of the lens.

The shaping lens may comprise side faces extending between the rear surface and front surface, perpendicular to the rear surface.

The lens may be a Plano-Convex (PCX) lens.

The light emitting elements may comprise point sources

The light emitting elements may be light emitting diodes (LEDs).

The array may have any number of light emitting elements.

The array of light emitting elements may be mounted on a support having a central axis. The light emitting elements may be arranged on a surface facing along the central axis.

The support may be frustoconical in shape, with the light emitting elements arranged an inner surface of the support. The array of light emitting elements may be mounted on a projection formed on the inner surface of the frustoconical support. The projection may have a surface facing perpendicular to a central axis of the support, the surface facing out of the end of the support. The array may be mounted on the surface of the projection.

According to a ninth aspect, there is provided an illumination device comprising: a support having a central axis and comprising a forward facing surface facing along the central axis; and at least one array of a plurality of light emitting elements mounted on the support, facing in the same direction as the forward facing surface, wherein the array is arranged in a string following a non-linear path extending radially outwards from the central axis.

Arranging the light emitting elements in this way, the elements can be positioned close together on the support in the radial direction, whilst still fitting in any control electronics. Furthermore, the light emitting elements and other components can be moved to their ideal position to ensure the support is better balanced as it is rotated.

The light emitting elements may be mounted on the forward facing surface.

The support may be frustoconical in shape, with the light emitting elements arranged on an inner surface of the support

Alternatively, the light emitting elements may be mounted behind the support. Openings may be formed in the support, aligned with the light emitting elements. The light emitting elements may be mounted such that they rotate with the support.

The array may be a first array. The illumination device may comprise a second array comprising a plurality of light emitting elements. The second array may be arranged in a string following a non-linear path extending radially outwards from the central axis.

The second array may be circumferentially spaced from the first array in a circumferential direction around the central axis. The second array may at least partially overlap the first array in a radial direction from the central axis.

Each light emitting element from the first array may be at the same radial position as a corresponding light emitting element from the second array. Alternatively, at least some of the light emitting elements from the second array may be at a different radial positions to any light emitting element from the first array.

The light emitting elements in the first array may all be a first colour, and the light emitting elements in the second array may all be a second colour, different to the first colour.

The second array may be spaced from the first array in a radial direction from the centre of the support, and may at least partially overlap the first array in a circumferential direction around the central axis.

The light emitting elements in the first array may be circumferentially offset from the light emitting elements in the second array, such that, in the circumferential direction, the light emitting elements of the first array are interleaved between the light emitting elements of the second array.

The light emitting elements in the first array and the second array may be the same or different colour.

The string(s) may follow an arc with respect to the forward facing surface of the support.

According to a tenth aspect, there is provided a method for projecting a plurality of different illumination patterns onto and into eye of a patient, the method comprising: providing a plurality of light emitting elements on a support, the support rotatable around a central axis, and the light emitting elements facing along the central axis; switching one or more of: modes of rotation of the rotatable support; and/or patterns of light emitting elements that are illuminated, such that different patterns are projected onto the eye.

Using the method, a wide range of different tests and measurements can be performed using a single device. The method allows for observation of both the anterior and posterior of the eye. By selecting different combinations of light emitting elements to switch on and off during rotation, different regions of the eye can be illuminated for particular examination.

A plurality of sets of light emitting elements may be provided, each set comprising one or more light emitting elements.

A first set may comprise a plurality of light emitting elements arranged in a string following a linear or arced path in a radial direction.

A first set may comprise a single elongate light emitting element extending radially on the support.

The method may comprise illuminating at least some of the light emitting elements of the first set and rotating the rotatable support.

Illuminating at least some of the light emitting elements of the first set may comprise one of: illuminating some or all of light emitting elements in the first set at the same time, such that a pattern of concentric rings is projected; or illuminating a single light emitting element, or a group of adjacent light emitting elements at the same time, such that a single ring is projected; or sequentially illuminating different single light emitting elements of the spiral array, such that a plurality of different rings are sequentially projected onto the eye.

The first set may be arranged to emit white light, infrared light, ultraviolet light; blue light, red light; green light or the first set may emit a mixture of light, such as a RGB mixture.

The light emitting elements may be RGB light sources. The method may comprise selectively switching the light emitting elements as the support is rotated, to project a pattern. The pattern may be a letter, number or another recognizable pattern. By asking the patient to identify the letter, number, or other recognizable pattern they can be tested for colour blindness.

The light emitting element(s) may be RGB light sources. The method may comprise emitting a single colour of light, and switching the colour as the support is rotated.

The method may comprise selectively switching the light emitting element(s) as the support is rotated to generate a flash of diffuse light that is projected onto the eye.

A further set of light emitting elements may comprise a two dimensional array of light emitting elements on the support; and a shaping lens arranged to focus the light emitted from one of the light emitting elements into a desired shape, such as, for example a slit, circle or ellipse.

The method may comprise selectively illuminating one of the light emitting elements in the two dimensional array with the support stationary, to project the light, in the desired shape, onto a first position on the patient's eye.

The method may comprise illuminating a different one of the light emitting elements to project the light, in the desired shape, onto a different position on the eye.

The method may comprise rotating the support to project the light, in the desired shape, onto a different position on the eye.

Another set of light emitting elements may comprise a single point source light emitting element.

The single point source light emitting element may be arranged to emit white light; infrared light; ultraviolet light; blue light; red light; green light or a mixture, such as RGB. The method may comprise rotating the rotatable support with respect to the mounting body, and illuminating the single point source light emitting element such that a ring is projected on the eye.

The single point source light emitting element may be arranged to emit blue light. The method may further comprise providing a tonometry attachment between the light emitting element and the patient's eye.

The method may further comprise the step of providing a lens between the light emitting element and the patient's eye.

According to an eleventh aspect, there is provided an illumination device comprising: a support; a sheet of flexible printed circuit board mounted on a front facing surface of the support; and one or more light emitting elements, mounted on the sheet of flexible printed circuit board.

The device is of simple and lightweight construction without unnecessary PCB or other support for components.

The support may be frustoconical in shape, with the light emitting elements arranged on an inner surface of the support

The illumination device may comprise a body on which the support is mounted. The support may be rotatable with respect to the body, around a central axis, the light emitting elements facing along the central axis.

The support may comprise one or more openings extending therethrough to allow the flexible printed circuit board to extend between the front facing surface and an opposing rear surface.

According to a twelfth aspect, there is provided an illumination device comprising: a body; a support comprising one or more light emitting elements; and a camera arranged along the central axis of the support; wherein the camera is pivotally mounted to the mounting body about a second axis which is substantially perpendicular to the central axis of the frustoconical support.

The device allows for greater operator control on what images may be captured and increases field of view.

The support may comprise an opening such that the camera may be arranged on a first side of the support, and may image an object on the second side of the support, opposite the first side.

According to an thirteenth aspect, there is provided an illumination device comprising: a body; a support having a central axis and one or more light emitting elements mounted on the support facing the same direction as the forward facing surface, along the central axis, wherein the support is arranged to rotate with respect to the body, around the central axis, further wherein the body comprises an attachment portion adjacent to the support, the attachment portion being configured to removably engage with one or more accessories such that, in use, the accessories are located in front of the support along the central axis.

By using removable accessories on the front of the device, a wide range of different tests and measurements can be performed. The device allows for observation of both the anterior and posterior of the eye. By selecting different accessories of, different regions of the eye can be illuminated and examined under different conditions, for particular examination techniques.

The attachment portion may be threaded such that accessories having a mating threaded portion can be attached to the attachment portion.

The attachment portion may comprise one or more magnets, such that magnetic attachments can be attached to the attachment portion.

The attachment portion may comprise metal conductors configured to contact corresponding conductors on an accessory such that the accessory can be powered and/or controlled in use.

According to a fourteenth aspect, there is provided an illumination device comprising: a support having a central axis, the support arranged to rotate about the central axis; and a light emitting element mounted on the support, facing along the central axis, the emitting element comprising a single elongate light emitting element, extending radially from the centre of the support.

The single linear light emitting element allows for uniform and continuous diffuse light to be easily generated in a simple manner, without gaps between light sources.

The light emitting elements may be mounted on the forward facing surface.

Alternatively, the light emitting elements may be mounted behind the support. Openings may be formed in the support, aligned with the light emitting elements. The light emitting elements may be mounted such that they rotate with the support.

The method of the tenth aspect may be performed on an illumination device according to any one of the sixth to ninth aspects, or any one of the eleventh to fourteenth aspects.

The wireless power and data transfer system may be used in the devices and methods of the sixth aspect, and the eighth to fourteenth aspects, and may also be used in any other application.

It will be appreciated that, unless mutually exclusive, features discussed in relation to one aspect may be applied, mutatis mutandis, to another aspect.

Embodiments will now be described, by way of example only, with reference to the accompanying drawings, in which:

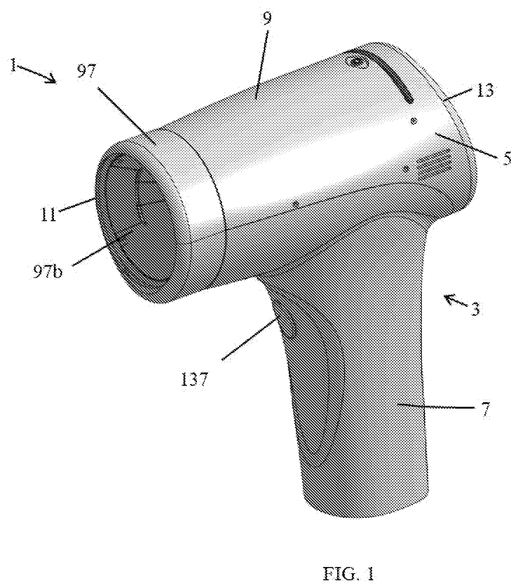

FIG. 1 illustrates a device according to an embodiment;

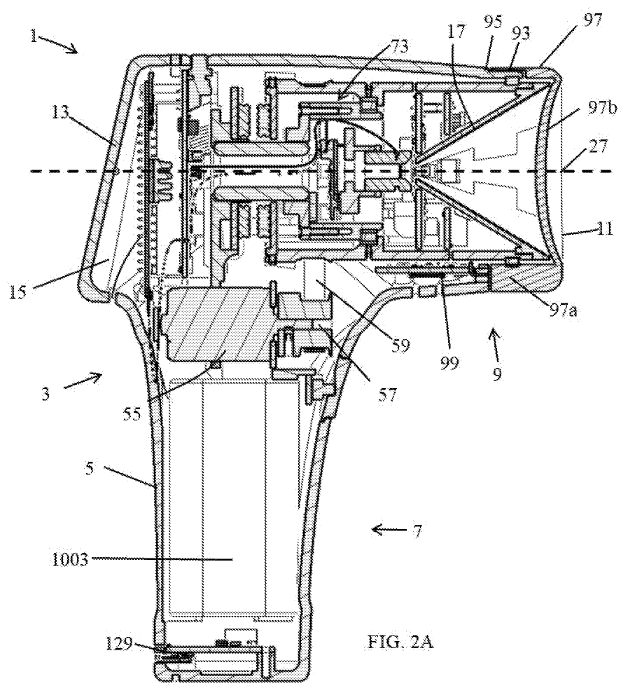

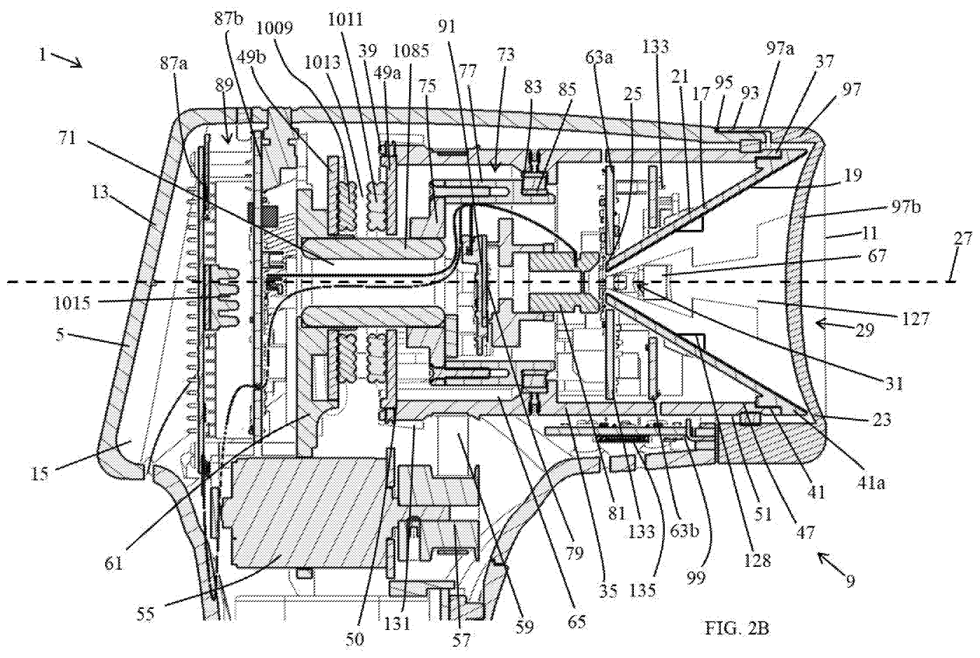

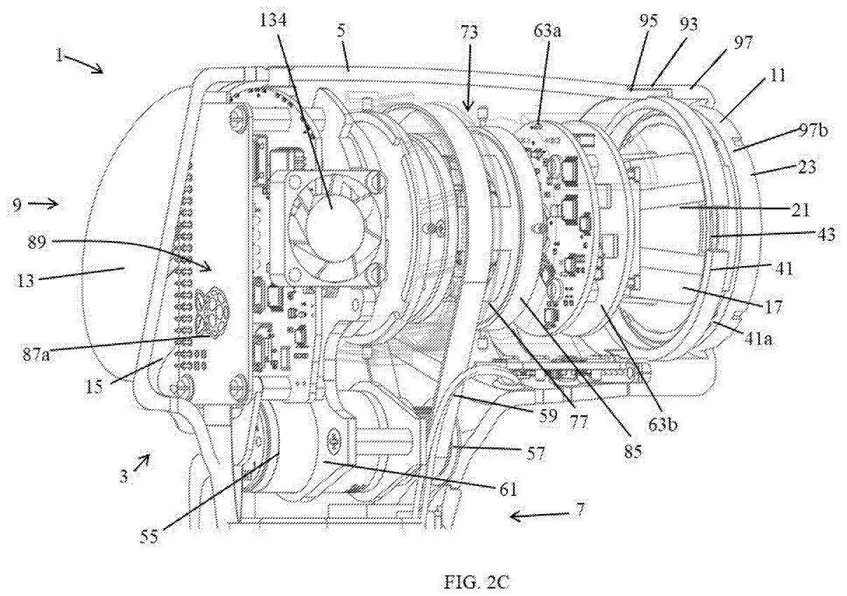

FIG. 2A illustrates the device of FIG. 1 in cut-through side view;

FIG. 2B illustrates the device of FIG. 1 in cut-through side view, showing the head portion in more detail;

FIG. 2C illustrates the device of FIG. 1 in cut-through perspective view;

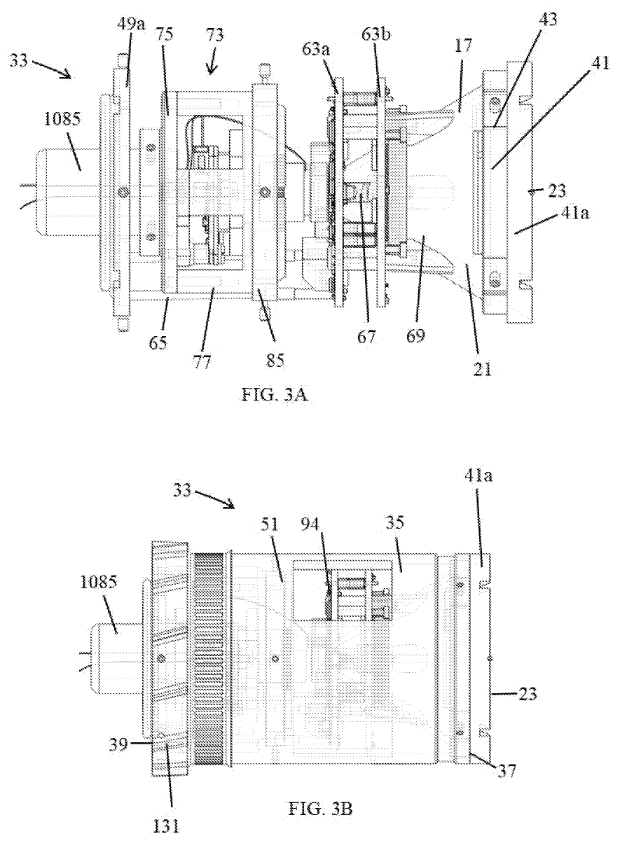

FIG. 3A illustrates the support assembly of the device of FIG. 1;

FIG. 3B illustrates the support assembly of FIG. 3A within the sleeve;

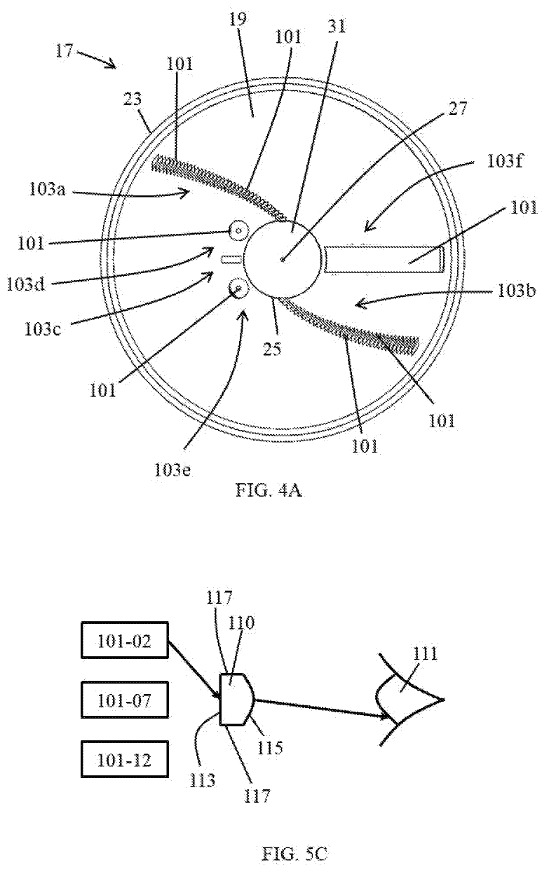

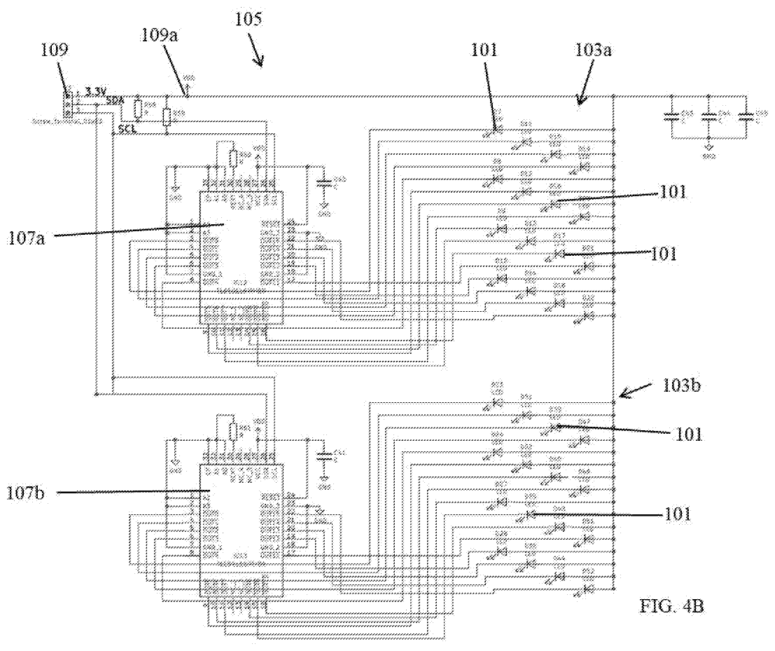

FIG. 4A illustrates a front view of a support showing a first example arrangement of light emitting elements;

FIG. 4B illustrates an example of control circuitry for light emitting elements;

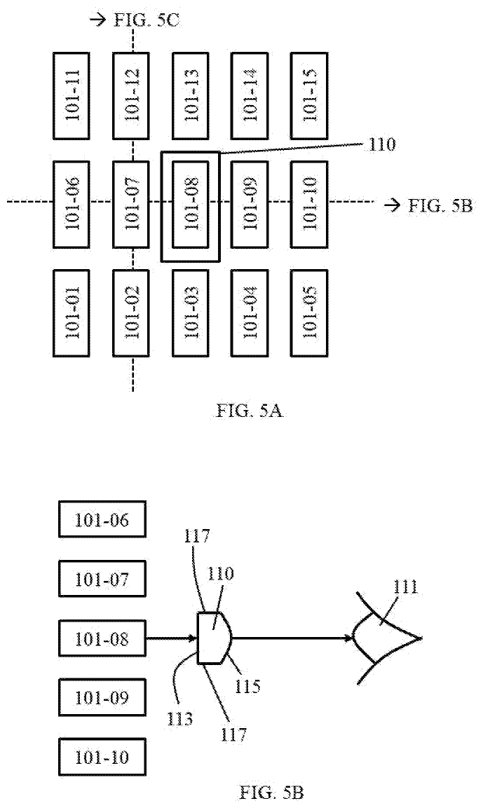

FIG. 5A schematically illustrates a front view of an array used to emulate a slit lamp

FIGS. 5B and 5C illustrate a side on view of the array of FIG. 5A, showing different projections of the slit;

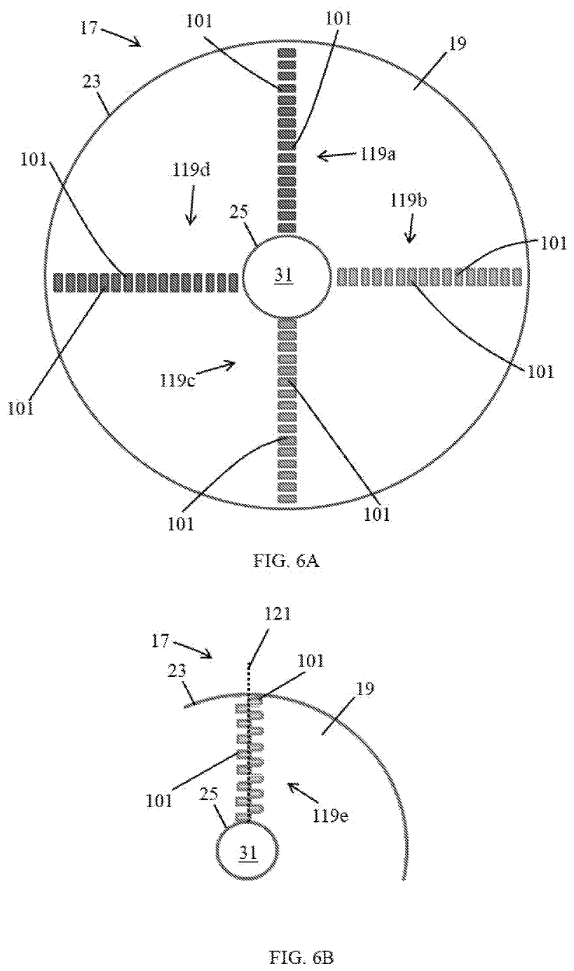

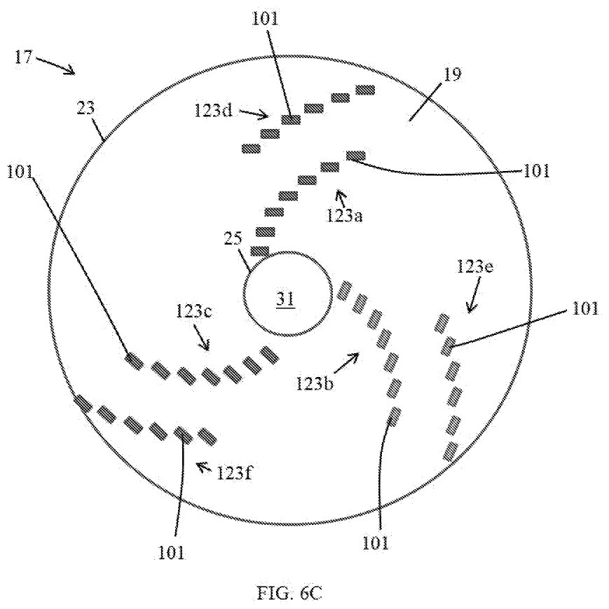

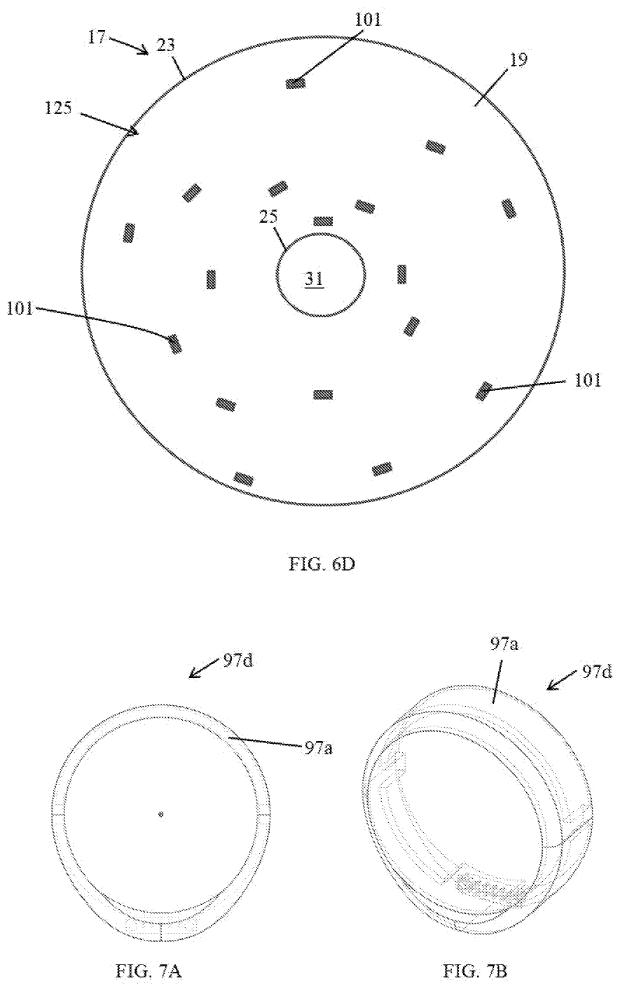

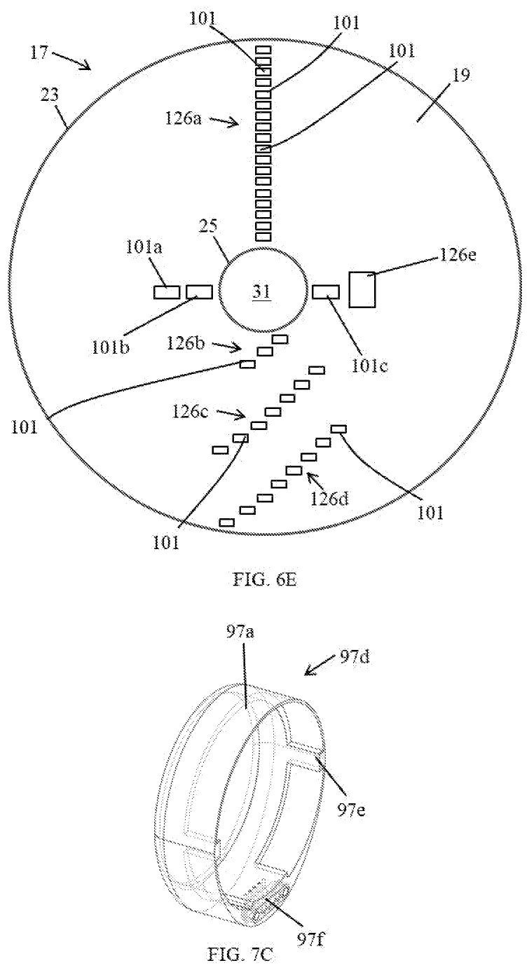

FIGS. 6A to 6E illustrate front views of the support, showing alternative arrangements of the light emitting elements;

FIG. 7A illustrates a front view of an example of an accessory to be connected to the front of the device;

FIG. 7B illustrates a front perspective view the accessory of FIG. 7A;

FIG. 7C illustrates a rear perspective view the accessory of FIG. 7A;

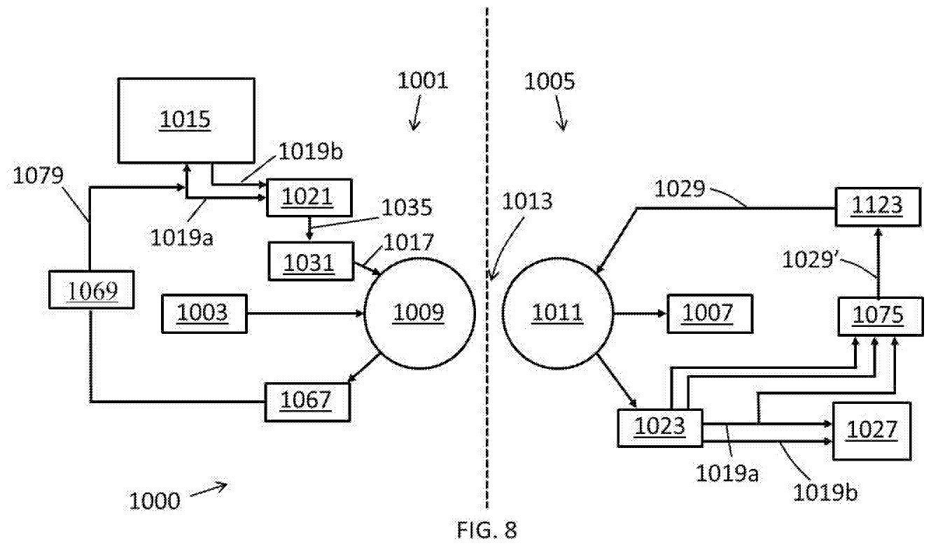

FIG. 8 schematically illustrates a wireless power and data transfer system;

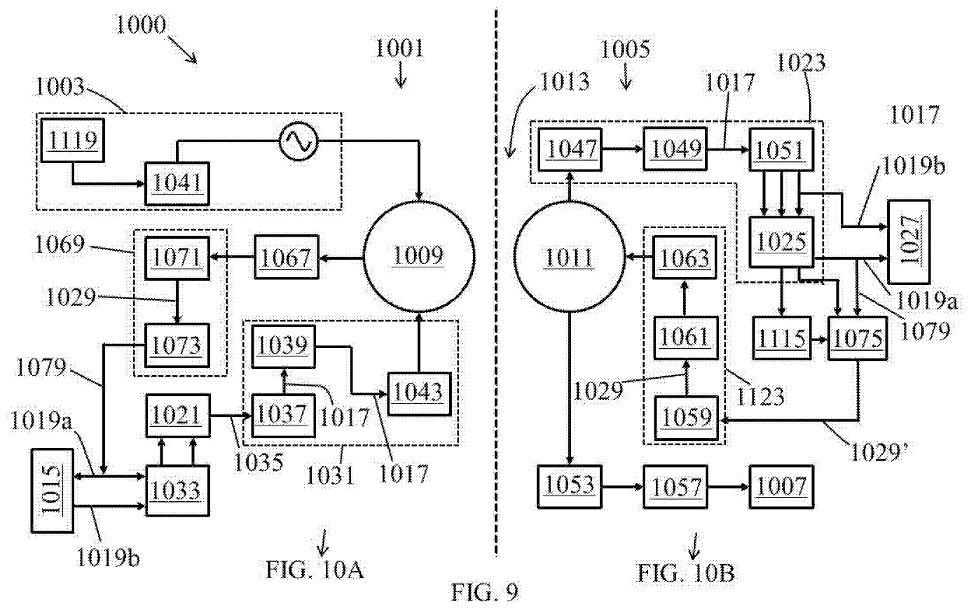

FIG. 9 illustrates a block diagram of the wireless power and data transfer system of FIG. 8;

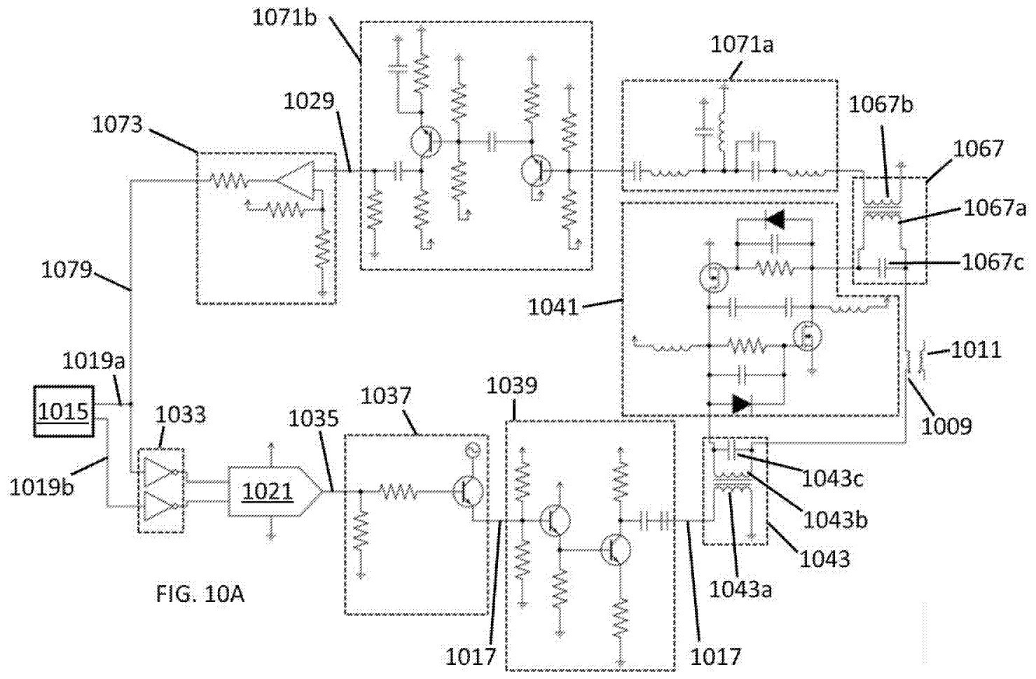

FIG. 10A provides a circuit diagram of the control circuit for the primary side of the system of FIG. 9;

FIG. 10B provides a circuit diagram of the control circuit for the secondary side of the system of FIG. 9;

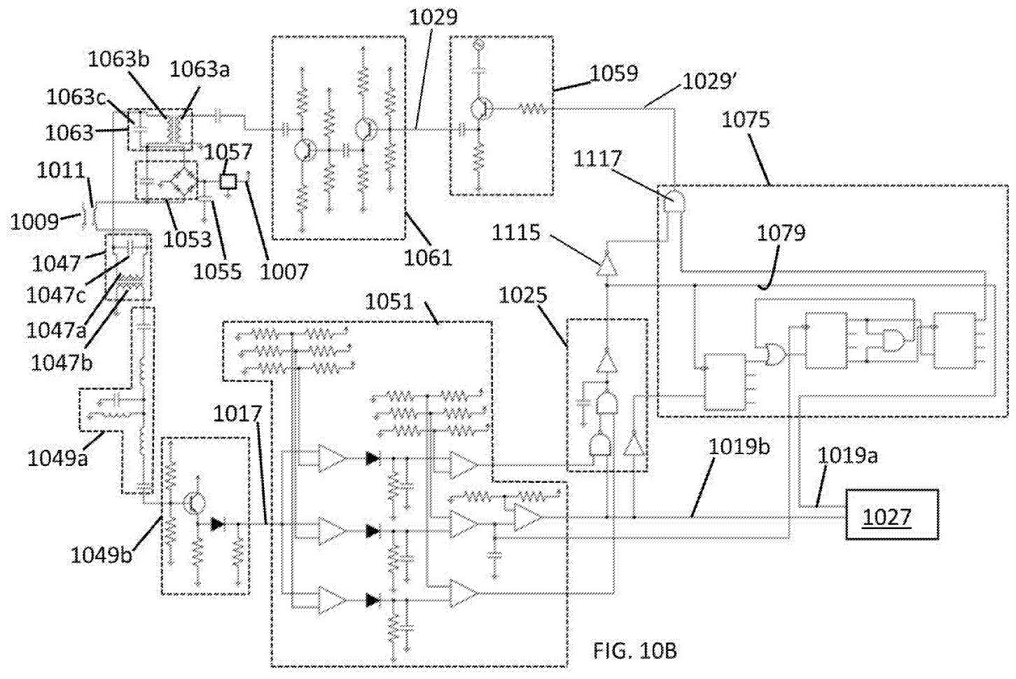

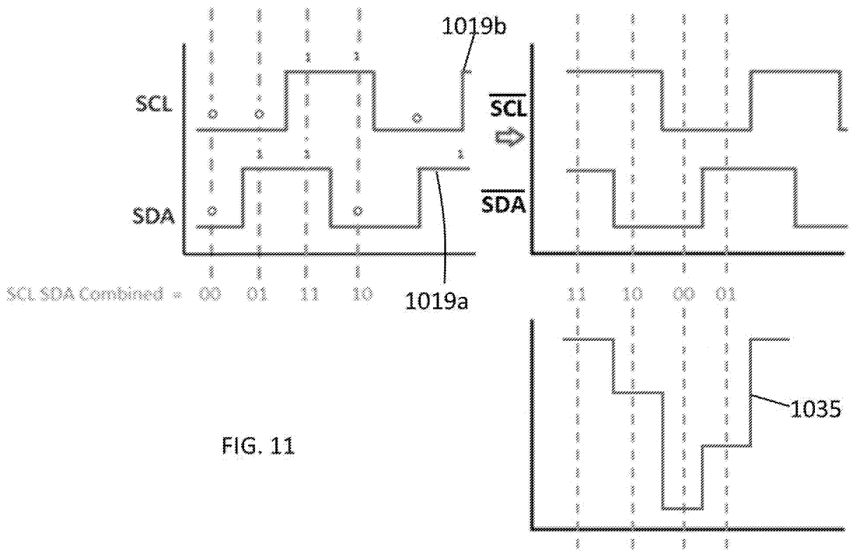

FIG. 11 illustrates the combination of a clock signal and data signal into a single analogue signal;

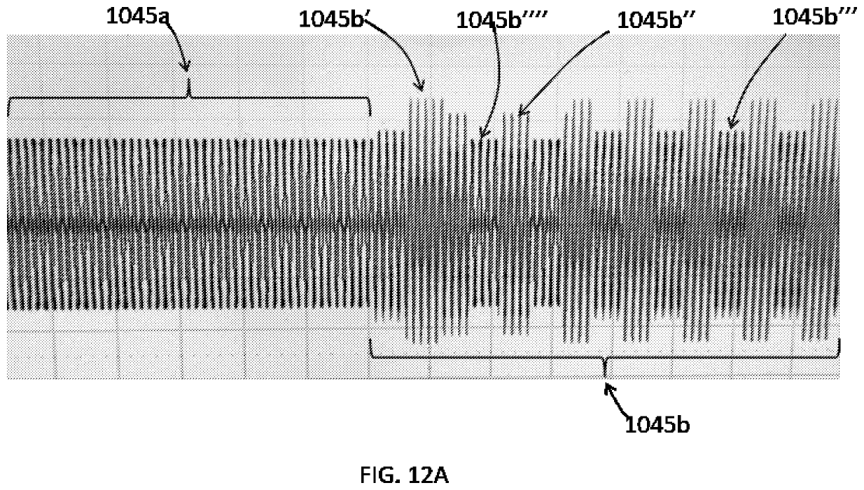

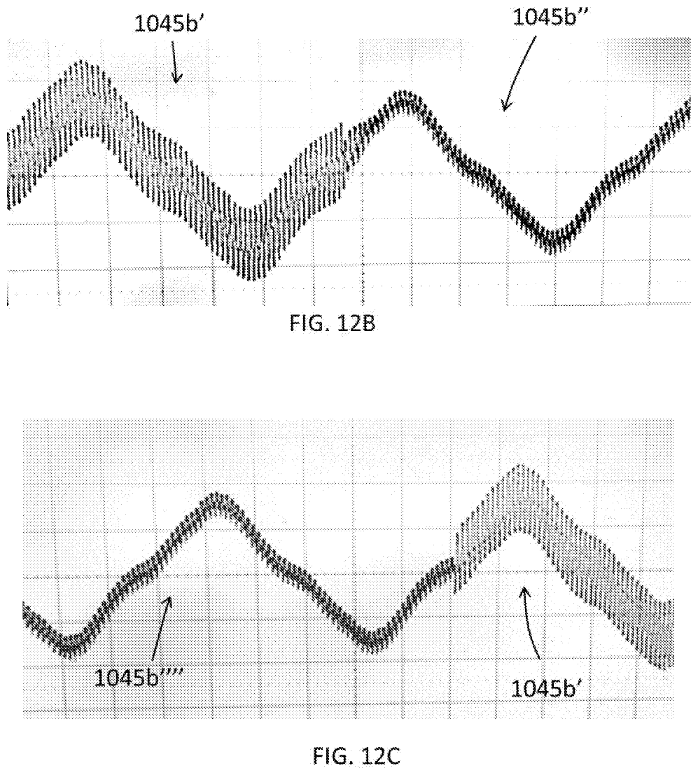

FIGS. 12A to 12C illustrate examples of a power signal with a modulated first control signal superimposed;

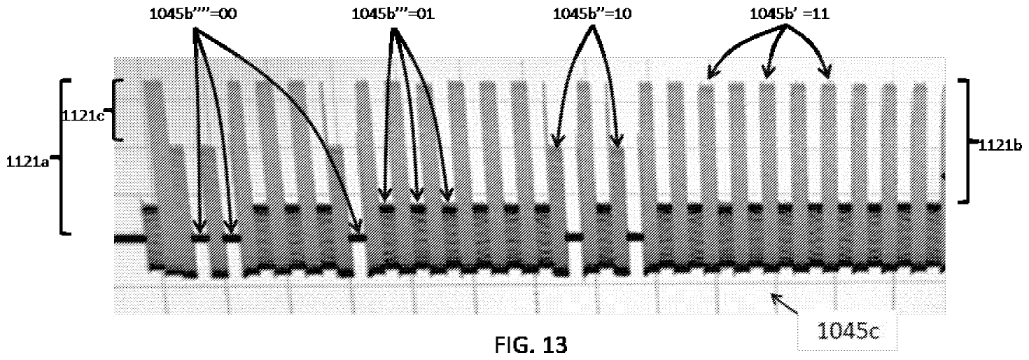

FIG. 13 illustrates an example of the signal induced at the secondary coil with the modulated first control signal superimposed once power signal and the modulated second control signal have been separated from the control signal;

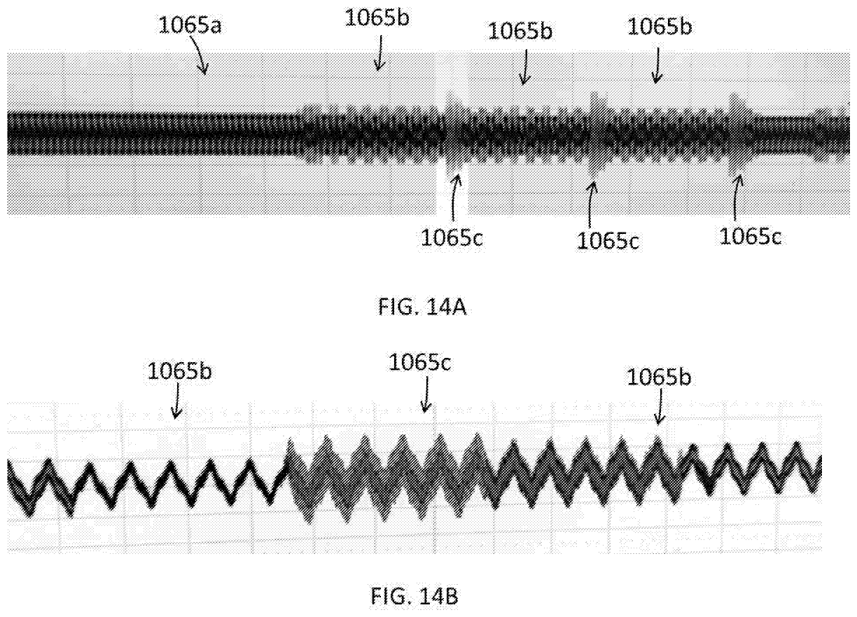

FIGS. 14A and 14B illustrate an example of the signal including the power signal, and modulated first and second control signals superimposed;

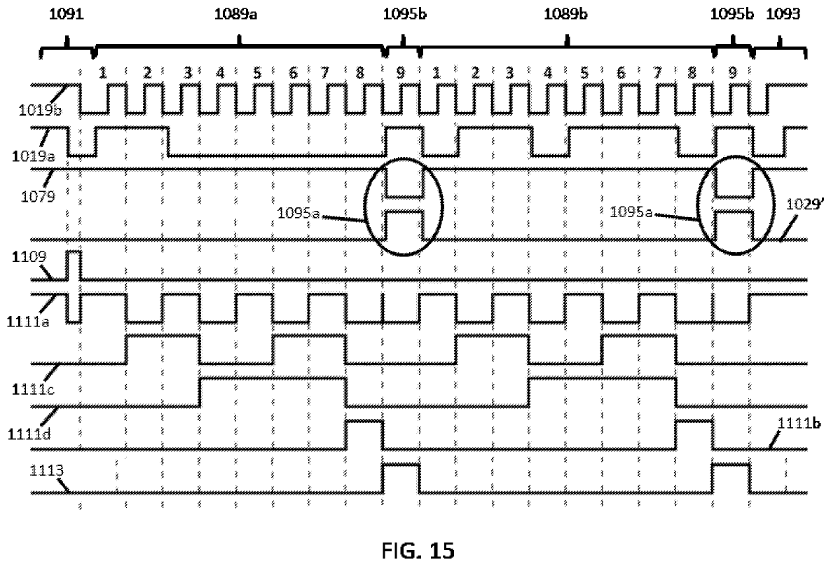

FIG. 15 illustrates the timing of an acknowledge window for I2C communication protocol;

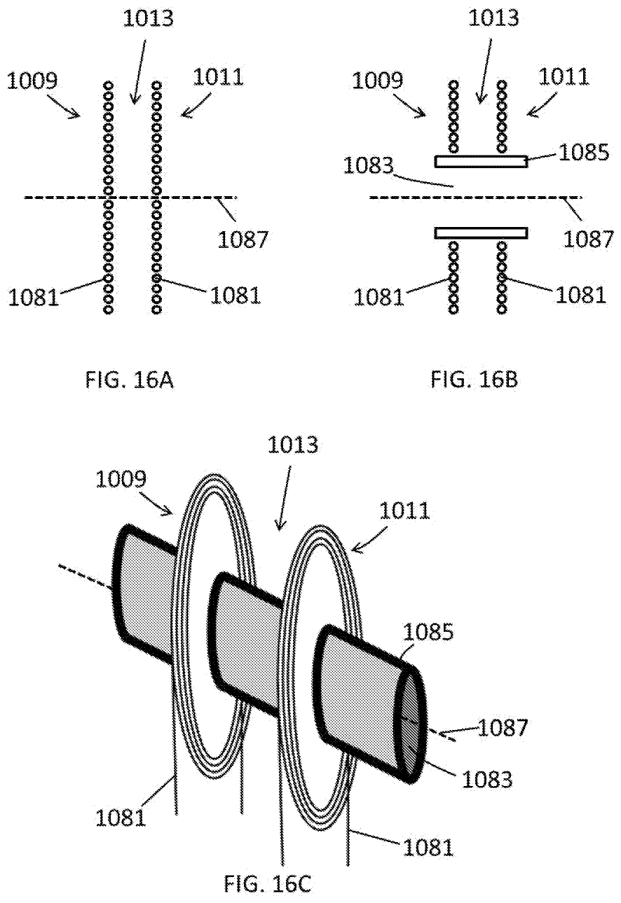

FIGS. 16A and 16B illustrate cut-through side views of examples of the coils of the wireless power and data transfer system of FIG. 8;

FIG. 16C illustrates 3D view of the coils shown in FIG. 16B;

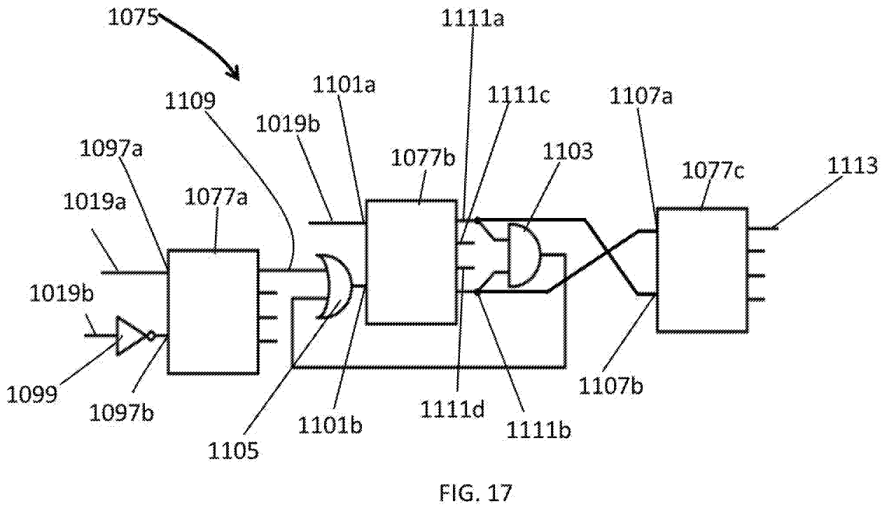

FIG. 17 illustrates the three counters responsible for monitoring the acknowledge time period;

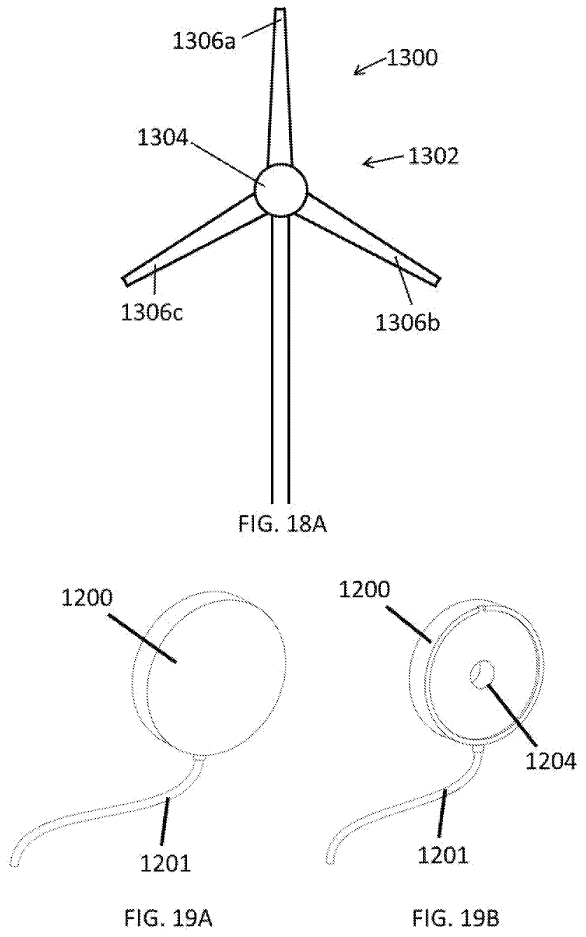

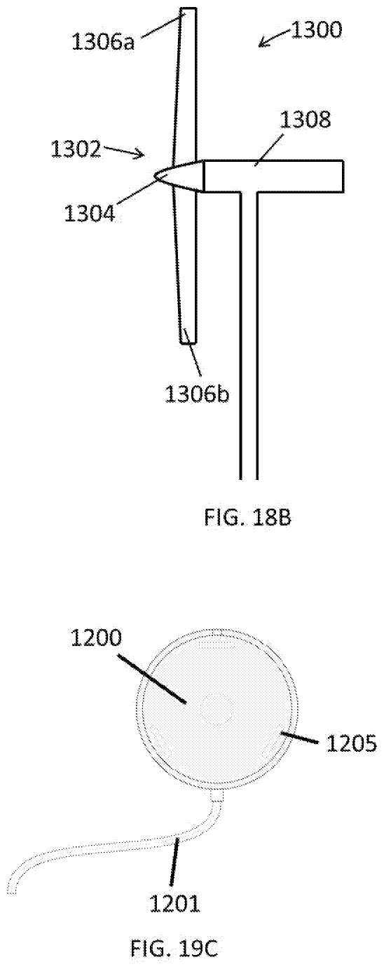

FIGS. 18A and 18B illustrate a wind turbine including the wireless power and data transfer system of FIG. 8 in front and side on view;

FIG. 18C illustrates a schematic sectional side view of the wind turbine of FIGS. 18A and 18B; and

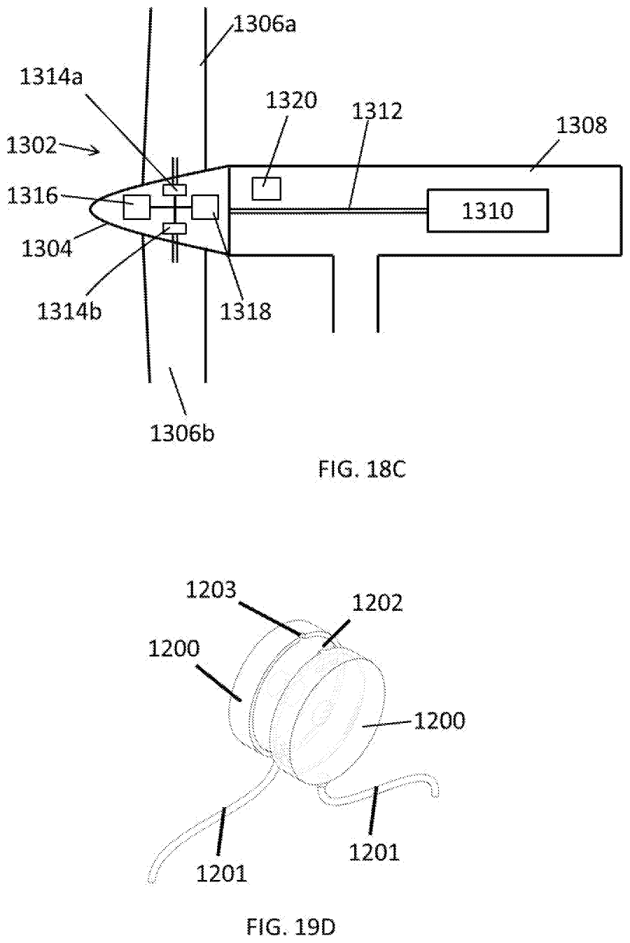

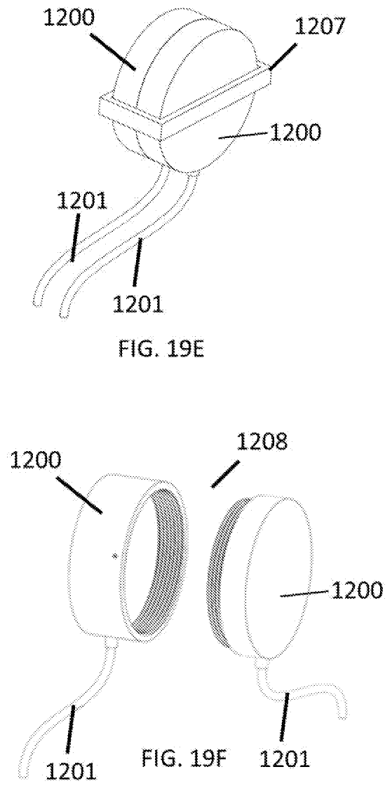

FIGS. 19A-F and 20A-C illustrate examples of detachable connectors using the wireless power and data transfer system of FIG. 8.

FIG. 1 shows a perspective view of a first embodiment of an ophthalmic device 1, that can be used to an eye of a patient (not shown).

The device 1 has a hollow body 3 formed by a housing 5. The body 3 has a handle portion 7 and a head portion 9 extending from the handle portion 7. In use, the handle portion 7 is held by an operator. The head portion 9 has a distal end 11 which is faced towards the eye of the patient and a proximal end 13 opposite the distal end 11.

FIGS. 2A to 2C show a cut-through view of the device 1, showing the internal volume 15 formed by the housing 5.

A support 17 is provided within the volume 15, at the distal end 11 of the head portion 9. The support 17 is in the form of a truncated cone, and thus may be considered frustoconical in shape. The frustoconical support has a distal end 23 having a first diameter and a proximal end 25 having a second diameter, smaller than the first diameter. The support 17 has an inward facing surface 19 on the inside of the cone, and an opposing outward facing surface 21 on the outside of the cone.

The distal end 23 of the support 17 is positioned at the distal end 11 of the head portion 9 of the body 3. The distal end 11 of the head portion 9 is open. The distal end 23 of the support is also open, with an opening 29. Therefore, the inner surface 19 is visible when viewed from the front of the device and faces towards the patient. In the below, the direction facing toward the patient will be referred to as forward facing 21, and the opposite direction will be referred to as rear facing.

The proximal end 25 of the support 17 is arranged within the volume 15 of the head portion 9. The proximal end 25 also includes an opening 31, to form a viewing window through the support 17. The openings 29, 31 in the distal end 23 and proximal end 25 of the support are arranged in planes parallel to each other.

A central axis 27 of the support 17 extends through the centre of the cone. The axis 27 passes through the centre of the opening 29 at the distal end 23 of the support 17 and the centre of the opening 31 at the proximal end 25 of the support 17. If the support 17 was formed of a full cone, with an apex at the proximal end 25, the axis 27 would also pass through the apex. Extending along the central axis from the proximal end 25 to the distal end 23, the support diverges outwards from the central axis 27.

As will be described in more detail below, with reference to FIGS. 4, 5 and 6A to 6E, a plurality of light emitting elements are arranged on the inner surface 19 of the support 17, and face towards a patient, in use. By illumination of the light emitting elements and optionally rotation of the support 17 about its central axis 27, patterns of light can be projected. For example, the light may be projected onto or into an eye of the patient, or any other body part.

As shown in FIGS. 3A and 3B, the support 17 may be provided within a support assembly 33. The support assembly 33 comprises an outer sleeve 35 with open ends 37, 39. In FIG. 3B, the outer sleeve 35 is shown as semi-transparent, to show the position of the support 17 within the sleeve 35.

At a first end 37 of the sleeve 35, the sleeve 35 is fixed to the distal end 23 of the support 17 such that the sleeve 35 rotates with the support 17. The sleeve 35 is cylindrical, with a central axis coinciding with the central axis 27 of the support 17, such that the support 17 extends within the sleeve 35, for part of the length of the sleeve 35.

The support 17 is fixed to the sleeve 35 by adhesive or mechanical fixing, welding or any other attachment means. In the example shown, the outer surface 21 of the support includes a ring 41 with recesses 43 that engage with corresponding projections 45 on the inside 47 of the sleeve 35. A further, enlarged ring 41a is provided at the end of the sleeve 35. This has the same diameter as the sleeve and aligns flush with the sleeve 35 when the support 17 is in place.

Near the second end 39 of the sleeve 35, opposite the first end 37, a first support plate 49a is provided. The first support plate 49a provides a support for an inductive coil 1011 arranged to receive power and control signals by wireless power transfer, as will be discussed below in more detail.

The first support plate 49a is located within the sleeve 35, near the second end 39. It is located against a lip 50 formed on the interior of the sleeve 35 and is fixed to the sleeve in a similar manner to the support 17 at the opposite end.

In the example shown, a pair of annular printed circuit boards (PCBs) 63a, 63b are provided around the outside of the support. These boards 63a, 63b include at least part of the control circuity (discussed in relation to FIG. 4B) for the light emitting elements. For example, this may include driver circuits and a microcontroller.

A connection 65 between the inductive coil 1011 and the PCBs 63a, 63b is provided within the sleeve 35.

It can be seen that a first PCB 63a is mounted at the proximal end 25 of the support 17. The support 17 may include one or more openings 67 extending from the outer surface 21 to the inner surface 19. This may provide a point for mechanically securing the PCB 65a, and also allows for connections to the light emitting elements on the inner (forward facing) surface 19. This may be provided as a substantially square opening at or near the proximal end 25 of the support 17. Alternatively, the opening 67 may be any size and shape and located at any position on the support 17. For example, the opening may be an arcuate slot provided through the support, extending around the axial direction 27 for part of the angular distance around the support 17. One or more openings 67 may be provided.

The second PCB 65b is spaced from the first PCB along the axial direction 27. This is supported by support lugs 69 formed on the outer surface 21 of the support 17.

On the outer surface 51 of the sleeve 35, a band 53 of troughs and ridges is provided extending round the circumference of the sleeve 35. The throughs and ridges 53 extend parallel to the axial direction 27.

A motor 55 is provided within the internal volume 15 of the device 1, in the handle portion 7. The output 57 of the motor 55 is coupled to the sleeve 35 by a drive belt 59. The drive belt 59 engages the band 53 of toughs and ridges on the outside 51 of the sleeve 35.

The motor 55 is rigidly secured inside the device 1 by a support structure 61. Therefore, as the motor 55 turns, the sleeve 35, the end plate 49a holding the coil 1011 and the support 17 also turn. Other components, such as the housing 5 and body 3 are stationary. The motor 55 and drive belt 59 are arranged such that the support 17 can be spun at up to speeds of 2000 rpm or higher.

As best shown in FIG. 2B, a second inductive coil 1009 is provided on a second support plate 49b, which is mounted on the support structure 61. As best shown in FIG. 2B or 2C, the second support plate 49b is provided outside the sleeve 35, adjacent the second end 39 of the sleeve 35. The second inductive coil 1009 is arranged to transmit power and may also optionally simultaneously transmit data. In other examples, the sleeve may be arranged to extend further towards the second support plate 48b, and the second support plate 49b may even be received within the sleeve 35.

The inductive coils 1011, 1009 face each other and are spaced by an air gap 1013 to provide wireless power and communications. As will be discussed in more detail below, the air gap 1013 may also be a vacuum gap, or another dielectric.

Both coils 1011, 1009 and the supports plate 49a, 49b of the support assembly 33 are annular in shape, with a central passage 71 formed along the axial direction 27. A hollow cylindrical core 1085 extends along the passage, between the two coils 1011, 1009.

At one end, the core 1085 is fixed to the support structure 61, and at the other end, the core extends into the sleeve 35, in the space formed between the first support plate 49a and the support 17.

As will be discussed below in more detail, the core 1085 may be made of a ferrite material, to improve power transfer between the coils 1011, 1009. Furthermore, the core provides a mount for a stationary module 73 housed within the sleeve 35.

When the sleeve 35 is rotated, the core 1085, transmitting coil 1009 and the stationary module 73 does not move, and electrical/communications connections can be passed through the passage 71, and the core 1085.

The stationary module 73 may include a base 75 extending perpendicular to the axial direction 27 and a side wall 77 extending from the base 75, around the axial direction 27. Within the sidewall, a camera 79 or any other suitable imaging module may be provided. The camera 79 is aligned along the axial direction 27 to image through the openings 29, 31 in the support 17. A lens 81 may also be provided.

In an optional embodiment, the camera may be able to rotate or “yaw” about one or two axes perpendicular to the axial direction 27, to allow for greater control of the images captured.

The camera 79 may be mounted on a PCB 91 secured to the side wall 77 or base 75 of the stationary module 73. The camera may be mounted on a cradle (not shown) that can be pivoted by servo motors also mounted on the PCB 91. Alternatively, the PCB 91 may be mounted to the side wall 77 or base 75 of the stationary module 73 to allow pivoting actuated by servo motors.

The lens 81 may be a fixed focal lens, a manual mechanical lens which allows for zoom and focal adjustment or a fluidic lens which allows for focal length adjustment and digital zoom. A fluidic lens requires electrical control connections, provided through the core 1085.

At the end of the stationary module 73 opposite the base 75, a lip 83 is formed in the sidewall 77, and an annular bearing 85 is provided between the stationary module 73 and the sleeve 35. Optionally the sleeve 35 is also located within the device 1 by bearings arranged between the outside surface 51 of the sleeve 35 and the housing 5.

A pair of control PCBs 87a, 87b are mounted within the volume 15 of the device 1. Primary control circuity 89 may be distributed between the control PCBs 87a, 87b. This may include a processor 1015 for controlling operation of the motor 55, and light emitting elements 101, fluidic lens 81, camera 79 and the like mounted on a first PCB 87a. The second PCB 87b may comprise a motherboard connected to the motor 55, and light emitting elements 101, fluidic lens 81, camera 79. The primary control circuity 89 may also include memory (not shown) and an interface module (not shown) in order to connect the device to allow remote control of the device (for example by Wi-Fi or Bluetooth), and also to transmit images from the camera 79. Images may be transmitted as they are taken, or stored locally and transmitted at a later date.

Connections to the processor/controller 1015 may be by any suitable wired or wireless connection. Where wired communications are used, a suitable port(s) may be formed in the housing 5 of the device 1.

A DC power source 1119 may also be provided in the volume of the device, for example in the handle portion 7. The DC power source 1119 provides power to the motor, to the primary control circuity 89 and to the light emitting elements 101 through the wireless power transfer.

Any suitable DC power source 1119 may be used. For example, a battery may be provided. The battery may optionally be rechargeable. The housing 5 may comprise a removable cover to allow replacement of the battery. Alternatively, power connections may be provided to allow recharging of the batteries in situ.

In other examples, the device 1 may include a mains connector to provide mains power to the device 1.

As best shown in FIG. 3B, the sleeve 35 may also include an opening 94 extending through it, to form an air vent. This ensure heat generated by the electrical components mounted on the support 17 can escape, and is not directed towards the patient. Additional cooling may be provided by cooling fins 131 formed on the outer surface 51 of the sleeve 31. In the example shown in FIG. 3B, the cooling fins 131 are formed on an enlarged region of the sleeve 35 proximally behind the formations which engage the belt 59. However, it will be appreciated that the cooling fins 131 may be provided in any suitable location. As the sleeve 35 rotates with the support 17, the cooling fins 131 cause increased circulation of air around the internal volume 15 of the device 1 to increase cooling.

In addition to the opening and cooling fins 131, a fan 134 may be provided to circulate cooling air around the internal volume 15 of the device 1. The fan 134 is shown in FIG. 2C, and may be formed in an opening (not shown) extending through the housing 5.

FIG. 4A illustrates a first example of the arrangement of the light emitting elements 101 on the inner (forward facing) surface 19 of the support 17. FIG. 4A is shown from the front of the support 17. The opening 31 in the proximal end 25 of the support 17 is in the centre of the support 17, and as the support 17 extends outward from this opening 31, the support also extends forward along the axial direction 27.

In the example shown in FIG. 4A, the inner surface 19 of the support 17 is provided with a number of sets 103a, 103b, 103c, 103d, 103e, 103f of light emitting elements. Each set has one or more individual elements 101.

In the example shown in FIG. 4A, the first set 103a and second set 103b of light emitting elements 101 are arranged at diametrically opposed positions around the support 17. Each of the first set 103a and second set 103b comprises an array of light emitting elements 101 arranged in a string following a path along the inner surface 19. When viewed from the front, the path is a non-linear path following an arc from at or near the proximal opening 31 to at or near the distal end 23.

In other words, in a direction moving out from the proximal opening 31, the position of each light emitting element 101 is rotated around the central axis 27 in a first direction compared to the preceding element. In the example, the first direction is anti-clockwise, so both the first set 103a and second set 103b extend anti-clockwise around the axis 27. However, the sets may both extend clockwise, or may extend in different directions.

FIG. 4B illustrates an example of the control circuitry 105 for operating the first set 103a and second set 103b of light emitting elements 101 as discussed above. It will be appreciated that any set of light emitting elements may have similar control circuitry 105.

For each set, a microcontroller 107a, 107b is provided. The microcontroller 107a, 107b independently switches the light emitting elements 101 in each set 103a 103b to create patterns, as will be discussed below. Commands to the microcontrollers 107a, 107b are received via the inductive coils 1009, 1011, through a connection 109 to the processor 1027.

The light emitting elements, and microcontroller(s) are all connected by, for example, conductive tracks, on the PCB 63a, 63b. Power to the system is provided at a connection 109a in the control circuit 105.

Returning to FIG. 4A, a third set 103c of light emitting elements 101 is arranged on the inner surface to emulate the projection from a slit lamp and for viewing the internal structures of the eye. The third set 103c will be described in more detail with reference to FIGS. 5A to 5C.

The third set 103c of light emitting elements 101 comprises a number of light emitting elements 101 arranged in a rectangular array on the inner surface 19 of the support 17. In the example shown the third set 103C comprises fifteen light emitting elements 101-01 to 101-15 arrange in an array of three rows and five columns. However, there may be any number of light emitting elements 101 arranged in any shape.

A shaping lens 110 is provided axially in front of the array of light emitting elements 101-01 to 101-15, as part of a module including the lighting elements 101 mounted and on the support 17. Although shown as rectangles, the light emitting elements may be point light sources. The lens 110 acts to shape the output from a single one of the light emitting elements into a rectangular slit to project onto the eye 111 of a patient. It will be appreciated that the shaping lens 110 can be replaced with different lenses that can project different light shapes such as, for example, circular or elliptical, instead of a rectangular slit.

In the example shown in FIGS. 5A to 5C, the lens has a first planar surface 113 adjacent the light emitting elements 101 and an apposed convex surface 115 spaced from the planar surface 113 and facing the eye 111 of the patient. A side wall 117 extends between the planar surface 113 and the convex surface 115. In one example, the lens may be a plano-convex (PCX) lens.

The shaping lens 110 is approximately positioned directly in front of the centre most light emitting element 101-08 in the array, and is sized such that it only overlies a single light emitting element 101. This is by way of example only. The shaping lens 110 may be provided at any position over the array, and may have any size overlapping some or all of the light emitting elements 101.

As with the first and second sets 103a, 103b, the light emitting elements in the third set 103c are independently switchable. By illuminating a single element, a rectangular slit can be projected onto the eye 111. Selection of which light emitting element is activated (and optionally the rotational position of the support 17) allows the direction of the projection to be controlled. FIGS. 5B and 5C show the array of light emitting elements 101-01 to 101-15 and lens 110 schematically in side-on view, showing different slit projections by different light emitting elements 101.

The remaining sets of light emitting elements 103d, 103e 103f each comprise single light emitting elements 101. The fourth and fifth sets 103d, 103e each comprise single point light sources, whilst the final set 103f comprises a single elongate linear light emitting element extending along at least a portion of the axial length of the support 17.

FIGS. 6A to 6E illustrate alternative arrangements of sets of light emitting elements on the inner (forward facing) surface 19 of the support 17.

In the example shown in FIG. 6A, the light emitting elements are provided in four sets 119a-119d, each arranged as a linear array extending in a radial direction from at or near the proximal end 25 to at or near the distal end 23. The light emitting elements 101 within each set are all at the same circumferential position around the support 17 so that when viewed from the front, they follow a straight path. The four sets 119a-d are provided equally spaced around the support 17. In alternative examples, the linear arrays 119a-119d may extending in any non-radial direction. The different sets may all extend parallel or non-parallel.

FIG. 6B illustrates an alternative example of arranging a set 119e of light emitting elements in a linear path. In this example, the light emitting elements 101 are provided in a zipper or staggered formation. Therefore, the light emitting elements 101 alternate on either side of a linear centroid 121, as they extend in the direction from the proximal end 25 to the distal end 23 of the support 17.

In the example shown in FIG. 6C, six separate non-linear arc sets 123a-123f are provided.

Three of the sets 123a-c are arranged in a similar manner to the sets shown in FIG. 4A. However, instead of the arc extending from at or near the proximal end 25 to at or near the distal end 23 of the support 17, the arc extends from at or near the proximal end 25 to a radial position between the proximal end 25 to the distal end 23 of the support 17.

Likewise, the remaining sets 123d-f are arranged in a similar manner to the sets shown in FIG. 4A. However, the arc extends from at or near a radial position between the proximal end 25 to the distal end 23 of the support 17 to at or near the distal end 23 of the support 17.

In one example, the arc for the second sets 123d-f starts from at or near the same radial position where the first three sets 123a-c end, and extends to at or near the distal end 23. In another example, the radially outer sets 123d-f may start at a radial position closer to the centre than the end of the radially inner sets 123a-c, such that the sets overlap around a ring taken between the proximal end 25 to the distal end 23 of the support 17. Alternatively, the radially outer sets 123d-f may start at a radial position outside the end of the radially inner sets 123a-c, such that there is a gap between the sets around a ring taken between the proximal end 25 to the distal end 23 of the support 17.

The first three sets 123a-c are all spaced around the support 17, and the second three sets 123d-f are also spaced around the support 17. Each one of the second three sets 123 is also arranged in a circumferential position such that the arc traced by one of the second sets 123d-f overlaps the arc traced by one of first three sets 123a-c. For instance, the fourth set 123d is arranged in the same angular range as the first set 123a, the fifth set 123e is arranged in the same angular range as the second set 123b, and the sixth set 123f is arranged in the same angular range as the third set 123c. Therefore, a radial line from the proximal end 25 to the distal end 23 may pass one of the inner sets 123a-c, and one of the outer sets 123d-f.

It may be, as shown in FIG. 6C, that the individual light emitting elements 101 of the overlapping pairs of sets are offset form each other circumferentially, so that there is only a single light emitting element at each angle around the support 17. Alternatively, the light emitting elements of overlapping elements may be arranged at the same circumferential position.

In other examples, the inner sets 123a-c and outer sets 123d-f may be at different angles, so that a radial line from the proximal end 25 to the distal end 23 only passes through one set. In further examples, the sets may partially overlap around the support 17.

In the examples shown in FIGS. 6A and 6B, each set of light emitting elements 101 extends substantially the full radial length of the support 17 form the distal end 23 to the proximal end 25. However, in the example shown in FIG. 6C, each only extends part of the radial length of the support 17. In FIG. 6C, there are two sets provided between the distal end 23 and the proximal end 25. However, any number of sets may be provided.

In the example shown in FIG. 6C, the sets follow a non-linear arc path. However, this may not be the case. In another example, the sets may follow a linear, but non-radial path. The different sets may all extend parallel or non-parallel.

In any embodiment with (linear or non-linear) arrays of light emitting elements 101 extending out from the centre of support 17, the spacing of the light emitting elements 101 may be even along the length of the array. Alternatively, light emitting elements closer to the distal end 23 of the support 17 may be spaced closer together than light emitting elements 23 near the proximal end 25 of the support 17. This ensures that the rings projected on the eye of the patient are of even widths.

FIG. 6D illustrates a support 17 provided with a single set 125 of light emitting elements 101, scattered in a pseudo-random or random pattern over the entire support 17.

It may be that no light emitting elements 101 are provided at the same and/or circumferential position, however, this may not be the case, and more than one light emitting element 101 may be provided at the same position along a radius or around a circumference.

FIG. 6E illustrates a further example of an arrangement of light emitting elements 101 on a support 17. This has a number of different sets 126a, b, c, d, e.

A first set 126a comprises a linear array extending in a radial direction from at or near the proximal end 25 to at or near the distal end 23.

A second set 126b comprises a set of light emitting elements 101 from at or near the proximal end 25 of the support 17 to a first radial position. A third set 126c comprises a set of light emitting elements 101 from a second radial position to a third radial position. A fourth set 126d extends comprises a set of light emitting elements 101 from a fourth radial position to at or near the distal end 23 of the support 17.

As discussed with reference to FIG. 6C, it may be that the first to fourth radial positions are arranged sequentially out from the proximal end, such that there is no overlap between the sets around any ring around the support. Alternatively, it may be that the radial positions are in any other order to allow for some overlap along a ring formed round the support. In yet another example, the first and second radial position may be the same, and the third and fourth radial position may be the same.

The second to fourth sets 126b-d are all formed in the same angular space around the support 17, substantially diametrically opposite the first set 126a.

In the example shown, each of the second set 126b, third set 126c, and fourth set 136b follow parallel non-linear paths, in a similar manner to the sets in FIG. 4A or 6C. However, it will be appreciated that these sets may also follow straight lines at an angle to the radial direction. The sets may be parallel or non-parallel.

A fifth set 126e is formed in a similar fashion to the third set 103c in FIG. 4a, with a rectangular array (not shown) and a shaping lens (not shown). A single white light point source 101a, a single infrared point source 101b, and a single RGB light source 101c are also provided. These are provided at or near the proximal end 25.

In the example shown, the fifth set 126e is provided at an angular position of around 90 degrees from the first set 126a, and near the proximal 25 end of the support 17. The RGB light source 101c is provide radially inside the fifth set 126e. The white light source 101a and infrared light source 101b are also provided at or near the proximal 25 end of the support 17, in a diametrically opposed position to the fifth set 126e and RGB light source. The infrared light source 101b is radially inside the white light source 101a. However, it will be appreciated that this is by way of example only.

Any suitable light emitting element 101 may be used. For example, the light emitting elements 101 may be light emitting diodes (LEDs). Lenses may be provided with each light emitting element 101.

All light emitting elements 101 within a single set may emit the same colour of light. For example, all light emitting elements within a set may be white, blue, red, green, infrared, RGB or ultraviolet light emitting elements. Different sets may have different colours. Alternatively, there may also be variation of the colour within a set. By mixing of light, either with light emitting elements of different colours, or by single light emitting elements arranged to emit a mix of colours, a range of different output colours can be generated.

It may be possible to secure a number of different accessories to the front of the device along the axial direction 27. This may include, for example, lenses, covers, filters, mirrors, prisms, pressure sensors, additional light sources, polarizers and frame structures to ensure correct positioning of the patient with respect to the device.

Referring to FIGS. 1 and 2A to 2C, the housing 5 includes a cylindrical section 93 at the distal end 11 of the device 1, surrounding the distal opening. A lip 95 is formed, extending radially outward, away from the distal end 11.

This narrowed region forms an attachment portion that can be used to locate and secure various accessories.

For example, FIGS. 2A and 2B illustrate the device 1 provided with a transparent cover 97 as an example of an accessory that can be fitted. The cover has a cylindrical portion 97a designed to fit around the attachment portion of the housing 5 and abut the lip 95. The cover 97 includes a front portion 97b extending over the front of the support 17. This can be used to protect the patient.

The cover 97 may be secured in place by, for example, screw threads, snap fit projections, magnets or other suitable releasable attachment means.

The cover 97 may have a coating to reduce reflections of the light emitting elements and reflected patterns from the object being measured. The centre of the transparent enclosure may have an opening where no material is present as this will allow for the camera lens to directly capture images without obtrusion. In addition, a possible soft interface (rubber sleeve or silicon edge) which will provide a soft contact point to rest the instrument onto the patient during testing. This contact point will provide an easy to clean surface to disinfect the instrument between patients.

FIGS. 7A to 7C illustrate an example of an alternative accessory 97d in more detail. In This example, the accessory 97d is ring shaped, with an open front.

The accessory 97d is secured to the housing 5 in the same manner as the cover 97. As best shown in FIG. 7C, the accessory 97d (or the cover) may include projections 97e that engage with corresponding formations on the housing (not shown) to prevent rotation of the accessory 97d or cover 97.

As with the cover 97, the ring shaped accessory 97d includes a hollow cylindrical region 97a which can fit over the corresponding attachment portion of the housing 5,

In some cases, the accessory may require power and/or data communications. Conductive input pins 99 are provided at the distal end 11 of the housing 5, with corresponding plugs 97f in the accessory 97d. These can be connected to the controller/processor 1015 and DC power source 1119 through the internal space 15 in the housing. Alternatively, a conducting slip ring arranged around the lip 95 may be used.

In some examples, the accessory may include a linkage or coupling (not shown) to the proximal edge 25 of the support 17. In this example, the projections 97e are omitted such that the accessory is free to rotate as the support 17 rotates.

In some embodiments, a formation or projection 128 may be formed on the inner surface 19 of the support. The formation is discontinuous around the support. Therefore, as the support is rotated, an air flow can be generated. Where such an air flow is to be directed at a patient, a cover 97 may include an opening or nozzle to allow passage of the air flow, and optionally shape it. Such airflow can be used to test a patient's tear film or blink response when exposed to windy conditions.

In one embodiment, the third set 103c of light emitting elements, which provides the slit lamp effect (or other shaped light), may be arranged on a projection with a surface perpendicular to the axial direction, with the array arranged on the surface.

It may be that the support 17 is interchangeable, with different supports having different sets of light emitting elements 101. Either just the support 17 or support assembly 33 may be interchangeable.

In the above example, a camera 79 is provided along the axial direction 27. However, in other examples, the camera 79 may be omitted. Instead, an opening may be provided in the proximal end 13 of the device 1, along the axial direction 27. This will allow an operator to directly view the patient's eye 111 along the axial direction, through the passage 71 in the inductive coils 1009, 1011 and through the openings 29, 31 in the support 17. Components should be mounted away from the axial direction to ensure a clear line of sight.

In other examples, the stationery module 73 may include a switchable arm (not shown) designed to move optical components, such as filters and the like, into and out of alignment with the camera 79. The arm may be mounted on PCB 91 and may be activated by any suitable MEMS motor or servo.

At least part of the control circuitry 105 for the light emitting device may be provided on a flexible PCB 127 mounted on the inner surface 19 if the support. The flexible PCB 127 may be connected to other parts of the control circuitry 105 through the openings 67 in the support 17. The flexible PCB 127 may be provided in a recess formed in the support 17, such that the surface of the support is flat and alignment is consistent for different supports 17 or devices 1. Alternatively, the flexible PCB 127 may be provided on top of the surface 19 of the support 17.

A connector 129 may be provided in the device 1 to allow for connectivity to a wider system. This may be a simply mechanical connection (interface pin or profile), or may also allow for power/data connection. For example, the connector may enable connection to a chin rest or another part of a topographer. This connector 129 may also be used for recharging batteries.

The connector 129 may be provided at any suitable position. For example, the connector 129 may be provided in the handle portion 7, in a base of the device 1.

As discussed above, the light emitting elements within each set are independently switchable, and each set is also independently controllable. Thus, various patterns may be projected by selecting which light emitting elements to activate and also controlling the rotation of the support 17 at the same time. For example, there may be different modes of rotation depending on speed, direction, axial extent of rotation.

An operator may then view the pattern on the patient's eye 111 for conducting various measurements and analyses.

Example of different patterns and/or different measurement techniques that can be achieved with different sets and accessories include
Projection of concentric rings for corneal topography or non-invasive tear film break up

A pattern of concentric rings can be projected in a number of different ways. For example, if the device 1 is held close enough to the eye 111 of the patient, and all light emitting devices in a single set are activated whilst the support 17 is rotated, concentric rings will be projected. Alternatively, concentric rings may be projected by only activating alternate light emitting elements in a single set, or spaced groups of light emitting elements in a single set. Different sets of light emitting elements can be switched on together to vary the density/light combination of concentric rings being projected.

In some cases, all rings may be the same colour. However, in other cases, rings of different colours may be projected, either by having different colour light emitting elements in a single set, or by projecting different rings from different sets. Any visible colour or infrared light may be used.
Projection of a single ring for gonioscopy, retinal imaging, convergence testing, axial length measurement, applanation tomography, and strabismus/nerve palsy measurement.

A single ring may be projected by illuminating a single light emitting element or a group of adjacent light emitting elements whilst the support 17 is rotating.

For convergence testing, white light is used as the instrument is held at distance to the patient.

For an axial length measurement, camera focus will be achieved by using the fluidic lens 81, which has short depth of field and is controlled electronically. If the camera 79 focuses on cornea this will be a particular focus value. If camera focuses on the retina this will be another focus value. The difference between focus values translates into axial length value. Optionally a lens attachment may be provided on the front of the device 1. White light or RGB light may be used to illuminate regions of the eye and allow for increased field of view when imaging the posterior region of the eye.

For a gonioscopy measurement, only white light may be used. A gonioscopy attachment may be provided on the front of the support 17. For retinal image, a Volk lens may optionally be provided on the front of the device 1. White light, RGB or IR light may be used to illuminate the retina with the assistance of the Volk lenes accessory.

For applanation tonometry, blue light is used, and a tonometry attachment is provided in front of the support 17. With the instrument held at a short distance away from the patient's face, a white or coloured light may be used for strabismus/nerve palsy measurement which will allow the camera to register alignment of both eyes concurrently.

### Visual Field Testing

A visual field test may be performed by projecting single point of light by turning on a particular light emitting element 101 during a defined moment during the rotation of support 17 and then turning the LED off for the remainder of the rotation. For example, a light emitting element in the first set 103a can be switched on at the 3 o'clock position during the rotation of the support 17, and then switched off for all other positions. Upon subsequent rotations this is repeated which gives the effect of a stationary point source being present at the 3 o'clock position. Alternatively, a light emitting element in set 103a may be switched on while the support 17 is stationary at the 3 o'clock position. The light emitting element can then be switched off, support 17 rotated to the 7 o'clock position and a different light emitting element in set 103 switched on. This method can be repeated for different light emitting elements 101 (optionally in different sets) at different distances between the proximal and distal end of the support 17. Through providing point sources at different locations around the circular rotation, the patients' visual field can be assessed.

### Colour Blindness Testing

By selectively switching light emitting elements of different colours (from the same or different sets) while the support is rotating, patterns, including letters and numbers, can be projected in the colours which the patient can be asked to recognize and identify.

### Diffuse Illumination

Diffuse illumination can be generated in a number of ways. For example, a set of light emitting elements may be illuminated with the support 17 rotating.

For the linear elongate light emitting element or sets containing individual light emitting elements, this will create diffuse, general illumination. Where a set including an array or string of light emitting elements, this will produce diffuse light when held far enough from the patient's eye 111. In some cases, rotation may not be required to generate diffuse light. Diffused light may also be created be means of a diffuser accessory.

This can be used to illuminate the full eye and perform various examinations such as: general examination of the anterior segment of the eye, examining scleral redness, lissamine green observation, lipid layer interferometry and white to white measurements (when using white light); fluorescent tear film break up and examination of fluorescent staining (when using colour light such as blue). A tuned yellow filter may be mounted in front of camera 79 but behind lens 81, to enable fluorescein viewing in conjunction with blue light emitting elements. This may be on the arm discussed above, to allow the filter to be removed when not required.

By using diffuse infrared illumination or an infrared light emitting element near the axial centre of the support 17, the meibomian glands of the eye 111 can also be assessed.

By rotating the support 17 with the light emitting elements switched off, and then turning the light emitting elements on for a short time a flash of diffuse light can be generated. This flash can be used for test such as pupillometry.

When a focussing lens attachment is provided in front of the support 17, focused light can be projected, for measurements such as loose lens retinoscopy.

Illumination of various wavelengths (or any other illumination pattern) can also be used for inspection of other body parts, other than the eye. For example, diffuse or collimated light, switching between sweeping wavelengths and analyzing the penetration depth may be used to identify skin cancer. This may be accomplished with a suitable accessory arranged to fit on the front end of the device, as discussed above.

### Slit Lamp Measurements

As discussed above, a slit of light can be projected using the third set 103c of light emitting elements in FIG. 4A.

The slit can be projected to a predetermined position by rotating the third set 103c to a particular axial position and selecting the corresponding light emitting element in the array 101-01 to 101-15. The position of the slit can be changed by rotating the support 17 and/or changing the activated light emitting element.

This can be used for various measurements, including cataract detection and categorization, sclerotic scatter and rear meniscus height. It will be appreciated that shapes other than slits may also be used for these measurements.

Sclerotic scatter can also be measured using concentric rings with light emitting elements only switched on at a radial position from the proximal 25 end of the support 17 that match the patient cornea diameter, with the support rotating.

### Quadrant Illumination

Appropriate switching of the light emitting elements as the support is rotated can mean that the light emitting elements are only activated for a certain portion of the rotation. This can allow for illumination of certain quadrants or segments of the eye 111. When illuminating quadrants using infrared, this can allow for autorefractor measurements by means of measuring reflected light gradients from the retina and crystalline lens. Changes of the reflected gradient indicate different crystalline lens properties which can be corrected with glasses/contact lenses/surgery.

### Evaporative Tear Film Breakup

As discussed above, at least some embodiments include an insert of formation on the inner surface 19 of the support 17 which generates an air flow as the support 17 is rotated. This can be used for examinations such as tear film breakup which will cause air to be blown on the eyeball and concentric rings being used to measure the time interval between focused rings and distorted rings.

Prior to performing any measurement, the patient will need to know where to look to correctly centre their eye 111. Before any measurement is taken, a single ring is illuminated close to the axis 27. The patient can then know where to look in the middle of the ring to centre their eye correctly for the tests to take place.

For various measurements, it may be necessary to know the angle of the support 17 in relation to the patient eye. Furthermore, certain measurements may call for the light emitting elements to be spun to a certain position and then illuminated. To keep track of the support 17 rotation angle different methods can be employed.

In one example, a magnet and hall effect sensor combination may be used. The magnet/s can be placed on either the support 17 with the hall sensors on the stationary body or vice-versa. As the magnet passes the sensor a change in electric signal is measured by the sensor and will allow the microcontroller to calculate the position of the support 17.

Alternatively, a mechanical connection may be provided between the support 17 and the stationary parts of the device 1. This may be through a physical connection, either through belt or gear or any other means which allows for the counting of the steps between support start position and desired end position. This can be counted through a microcontroller.

In yet further examples, the support 17 may have a printed alignment plate or cut out teeth which allows for rotation angle to be measured through use of light.

In another example, light emitting elements 133 may be provided on one or both of the PCBs 63a, 63b mounted on the support 17, at known positions. Detectors 135 arranged around the inside of the housing detect the light emitting elements, to determine rotational position. In one example, light emitting elements may be provided at diametrically opposed positions on the different PCBs 63a, 63b.

In yet further examples, the device 1 may simply determine rotational position based on a known start point, calibration of the duration and speed of running the motor.

The above are simply examples of measurements and assessments that can be performed using the device 1.

It will be appreciated that processor 1015 may be used to control operation of the device. The primary control circuitry 89 may be provided with a memory that includes computer program instructions that, when executed on the processor 1015 causes the processor to control the light emitting elements 101 and the support 17 rotation to project the patterns required. A user may be able to interact with the commands in order to, for example, select a preprogramed route, correctly position the slit (or other shaped) projection or select a quadrant or sector to be illuminated. This may be accomplished by a connected device through the interface module discussed above.

It may be that the user is also able to programme new procedures.

The device may be provided with a control 137 to start a selected procedure. The control 137 may be positioned in an ergonomic position, such that the device can be positioned relative to the patient and the procedure started without having to move the device 1. The control 137 may be positioned to be ergonomically accessed by an operator, or the patient if they are self-testing.

In some examples, the control may also include a biometric sensor (for example fingerprint) to allow operators to login.

A screen may be provided on the device or separately to allow viewing of images in real time. This may be provided on any suitable surface of the device 1. For example, this may be positions at the proximal end.

It may be that each image captured only shows a portion of an area of interest. The memory may include software instructions to stitch images together, using various known techniques. The memory may also include software instructions to implement various image processing techniques to capture good quality pictures, such as autofocus.

The processor and memory may also include instructions for the communications protocol to provide instructions to the light emitting elements 101 over the inductive coils.

It will be appreciated that control of, in particular, the components mounted on the support 17 (such as the light emitting elements 101) may be distributed between the primary processor 1015, the processor 1027 on the support and the microcontrollers.

A continuous wireless power and data transfer system will now be described in more detail. The system may be used in the devices 1 discussed above, and also in any other suitable application where continuous wireless power and data transfer is required.

It will be appreciated that in the description of the wireless power and data transfer system the term “primary” will be used to refer to anything on the side of the circuit from which power is transmitted and the term “secondary” will be used to refer to anything on the power receiving side of the circuit. The electronic connection between the primary and secondary side is inductive coupling through a single pair of coils.

As will be discussed in more detail below, the system has an inverter for continuously generating an AC power signal with a first frequency flowing through a primary coil. This AC power signal is induced in a secondary coil. Therefore, the secondary side has a continuous AC power signal with the same frequency as the primary side. For data communications, the primary side superimposes a modulated first control signal onto the power signal at the primary side and the secondary side superimposes a modulated second control signal onto the power signal at the secondary side.

The first and second control signals are modulated for superimposing onto the power signal. As the modulated first control signal from the primary side has a second frequency and the modulated second control signal from the secondary side has a third frequency, the first and second control signals are treated as a single data channel each.

However, the system discussed below is capable of transferring multiple data channels. Should additional data channels be required, they are combined on either the primary or secondary side into a single modulated control signal (channel) that can then be superimposed onto the power signal.

FIG. 8 schematically illustrates a wireless power and data transfer system 1000. The system 1000 has a primary side 1001 including a power source 1003 and a secondary side 1005 including a power load 1007 that receives power from the power source 1003.

Power is transmitted from the primary side 1001 to the secondary side 1005 by inductive coupling between a primary coil 1009 coupled to the power source 1003 by conductive connections and a secondary coil 1011 coupled to the load 1007 by conductive connections.

In the example of the illuminating devices 1 discussed above, the primary side is on the body 3, the secondary side is on the rotating support 17, and the power load 1007 includes the light emitting elements 101 mounted on the support 17. However, it will be appreciated that the wireless power and data transfer system can be used to transfer power to any suitable load and to provide data communications. The load could be formed with the secondary circuit 1005 or separately.

Although the coils 1009, 1011 are shown as side by side in the FIGS. 8, 9, 10A and 10B, the person skilled in the art will appreciate that this is for illustrative purposes only. As shown in FIGS. 2A, 2B and 16A-C, the primary coil 1009 and secondary coil 1011 are arranged in parallel planes, and are separated in a perpendicular direction by an air or vacuum (or dielectric) gap 1013. The coils 1009, 1011 at least partially overlap each other when viewed along the perpendicular direction.

The air or vacuum gap may be any suitable distance. In one example, the air or vacuum gap may be <20 mm. However, the person skilled in the art will appreciate that similar levels of power transfer can be maintained for a larger air or vacuum gap by increasing the power source voltage or coil area.

As will be discussed in more detail below, a modulated first control signal 1017 is superimposed (or injected) into the power signal at the primary coil 1009 and a modulated second control signal 1029 is superimposed onto the power signal at the secondary coil 1011.

The modulated first control signal originates from a primary processor 1015. It is received as a component of the signal induced in the secondary coil 1011 and is fed to a secondary processor 1027 after demodulation. This modulated control signal may be used to control operation of the load 1007 (light emitting elements 101) or other components provided on the secondary side.

The modulated second control signal 1029 originates from the secondary processor 1027. It is received as a component of the signal induced at the primary coil 1009, and is fed back to the primary processor 1015 after demodulation.

In some examples, such as the 12C communication protocol, the second control signal 1029′ may be an acknowledge signal for commands sent using the first control signal 1019a, 1019b. In other examples, the second control signal may be any other type of communication signal. The below example will be discussed with reference to the I2C protocol.

As shown in FIG. 9, the secondary side 1005 includes a filter 1047 which extracts the modulated first control signal 1017 from the power signal and the modulated second control signal 1029. Likewise, the primary side 1001 includes a filter 1067 which extracts the modulated second control signal 1029 from the power signal and the modulated first control signal 1017.

To ensure proper co-ordination of real-time bidirectional communications between the primary side 1001 and secondary side 1005 of the system 1000, the clocks of the processors 1015, 1027 are synchronized. In the current example, for the I2C communication protocol, the first control signal 1035 includes a data signal component 1019a and a clock signal component 1019b, both generated by the primary processor 1015. It will be appreciated that, in general, the data signal and clock signal may be provided on two separate channels, illustrating multi-channel communication.

The data signal component 1019a provides the commands/communication whilst the clock signal component 1019b is used to provide synchronization. The data signal component 1019a and clock signal component 1019b are combined at a combination module 1021 on the primary side to form a single signal and separated at an interpretation module 1023 on the secondary side 1005 to extract two original data signal component 1019a and clock signal component 1019b from the combined single signal.

The primary side 1001 of the system 1000 and the secondary side 1005 of the system 1000 are formed as separate circuits, only inductively connected through the primary and secondary coils 1009, 1011. Each circuit has a circuit ground, and there is no ground connection between the primary and secondary side. Therefore, the primary side 1001 and the secondary side 1005 can be two completely separate circuits which should be separated by a defined distance depending on the application.

FIG. 9 illustrates a block diagram of one example of how to implement a continuous wireless power and data transfer system 1000 as discussed above. Example circuit diagrams for the primary side 1001 and secondary side 1005 are shown in FIGS. 10A and 10B respectively. It will be appreciated that various intervening components shown in the circuit diagrams are examples only, and may be changed or removed.

The communications may be through any known protocol. The below example will be discussed in relation to the I2C protocol.

As discussed above, on the primary side 1001 of the system 1000, a primary processor 1015 generates a data signal (SDA) 1019a and a clock signal (SCL) 1019b.

The data signal 1019a is a binary digital signal having a low state (0) and a high state (1). The switching between the states encodes data for transmission. The clock signal is likewise a binary digital signal having a low state (0) and a high state (1). The clock signal has a regular frequency for switching between the states, to ensure correct synchronization of data communication between the primary side 1001 and secondary side 1005, with the primary processor 1015 acting as leader (Master), and the secondary processor 1027 as follower (Slave).

The clock signal 1019b may have any frequency (f_{d}) between 1 kHz and 1000 kHz. For example, in the below it will be assumed that f_{d}=10 KHz. Different f_{d} values may be used in I2C communications and also in different communication protocols.

The data signal 1019a and clock signal 1019b are inverted by a logic inverter gate 1033. The logic inverter gate 1033 flips the signals by transforming digital high states into digital low states and digital low states into digital high states. In the I2C protocol (and many other communications protocols) the clock and data outputs are default high states when no data is sent. This requires constant power to transfer these high states to the secondary side 1005. By inverting the signals, power consumption of the system is reduced.

The inverted data signal 1019a and clock signal 1019b are provided to the combination module 1021 to generate a single analogue signal including both binary values. In other applications, the combination module 1021 can combine more than two digital signals to one analogue signal for transmitting more than two data channels from one side to another in real time.

In the example shown in FIGS. 9 and 10A, the combination module 1021 comprises a digital to analogue converter that generates an analogue signal 1035 adopting one of four different voltage levels corresponding to the two digital input states, as shown in table 1 below. FIG. 11 shows the combination of the inverted signals into the combined signal 1035.

TABLE 1

| Clock | Data | | | |
|---|---|---|---|---|
| signal | signal | | | |
| 1019b | 1019a | | | |
| (output | (output | Clock | Data | Combined |
| from | from | signal | signal | signal |
| processor | processor | 1019b | 1019a | 1035 |
| 1015) | 1015) | (inverted) | (inverted) | (voltage) |
| 1 | 1 | 0 | 0 | V₀₀ |
| 1 | 0 | 0 | 1 | V₀₁ |
| 0 | 1 | 1 | 0 | V₁₀ |
| 0 | 0 | 1 | 1 | V₁₁ |

In the example of FIG. 11, V₀₀<V₀₁<V₁₀<V₁₁, but this is by way of example, and the four input states (00, 01, 10, 11) may be represented by any suitable differentiable voltages. Similarly, the wireless power and data transfer system 1000 is compatible for combining more than two digital data channels. For example, eight different voltage levels are required for combining three digital signals. In general, for N data channels, 2^{N} voltage levels are required.

The analogue signal 1035 is superimposed to the power signal at the primary coil 1009 by superimposing module 1031. To allow for this, first the analogue signal 1035 is modulated onto a first carrier signal with frequency f_{c1} to generate the modulated first control signal 1017 by a modulation module 1037. In the example being discussed, Amplitude-Shift Keying Modulation (ASK) with carrier frequency of f_{c1}=4.9152 MHz is used for modulation of the first control signal. Any other type of modulation and any other carrier frequency may be used.

An amplifier 1039 is also provided to amplify the modulated first control signal 1017 prior to superimposing onto the power signal.

Typically, the power source 1003 will include a DC power source 1119 (for example a 5V DC power source). However, for inductive wireless power and data transfer, an AC power signal is required. Therefore, a power inverter 1041 is also provided within the power source.

In the example shown in FIG. 10A, the power inverter 1041 is an auto-tuned differential pair LC oscillator. This inverter generates a power signal of frequency fₚ between 80 kHz and 150 kHz.

The frequency of the power signal may be changed based on the amount of current drained by the secondary side 1005. For low power consumption on the secondary side 1005, up to 1 W, the frequency fₚ is between 80 and 100 kHz, and for higher range of power consumption on the secondary side, the frequency fₚ is between 140 and 150 kHz. Therefore, the secondary circuit 1005 can draw any amount of current, and the power inverter 1041 of the primary circuit 1001 automatically responds and supplies the required current.

An inductive transformer 1043, including an LC filter, is provided on the primary side 1001 of the system. A first coil 1043a of the transformer 1043 is connected in series to the amplifier 1039 for amplifying the modulated first control signal 1017. A second coil 1043b of the transformer 1043 is connected in series with a second inductive transformer 1067 (discussed below in more detail) and the primary coil 1009 of the wireless power and data transfer system 1000. The LC filter 1043c is formed by the second coil 1043b of the inductive transformer 1043 and a capacitor connected across the second coil 1043c. The filter is a bandpass filter centred on the carrier frequency of the modulated first control signal (f_{c1}) and removes the frequency of the power signal and any other modulated control signals, as discussed below.

The primary inductive transformer 1043 allows the modulated first control signal 1017 to be superimposed on top of the power signal at the primary side 1001.

The primary inductive transformer 1043 is selected to provide a significant difference between f_{c1} and fₚ in order to minimize the interferences and allow for easier separation of signal into constituent components on the secondary side 1005.

FIG. 12A shows an example of the signal generated by superimposing the modulated first control signal 1017 onto the power signal. In a first region 1045a, the trace shows a power signal without any superimposed control signal 1017 due to using the logic inverter gate 1033. In a second region 1045b, the trace shows a power signal with the varying superimposed control signal 1017.

The second region 1045b includes:
One or more sub-regions 1045b′ in which the clock 1019b and data signal output 1019a from the primary processor 1015 are both low (0)—as a result of using the logic inverter gate 1033, this now has the highest amplitude (V₁₁ in table 1).
One or more sub-regions 1045b″ in which the clock output 1019b from the primary processor 1015 is low (0) and the data output 1019a is high (1) (V₁₀ in table 1).
One or more sub-regions 1045b′″ in which the clock output 1019b from the primary processor 1015 is high (1) and the data output 1019a is low (0) (V₀₁ in table 1).
One or more sub-regions 1045b″″ in which the clock 1019b and data 1019a signal output from the primary processor 1015 are both high (1)—as a result of using the logic inverter gate 1033, this now has the lowest amplitude (V₀₀ in table 1), as shown in the first region 1045a.

As can be seen in FIG. 12A, superimposing the modulated first control signal 1017 causes an increase in the amplitude of the power signal, with the increase proportional to the voltage value of the analogue signal. For example, in the case where the clock 1019b and data 1019a output from the primary processor 1015 are both high (1) (V₀₀ in table 1), the amplitude of the signal is unchanged.

FIG. 12B illustrates a close up on the region of the trace where the modulated first control signal 1017 is superimposed onto the power signal and the logical states are changed: the clock and data output of the primary processor 1015 from both being low (0) (V₁₁ in table 1) to the clock signal being low (0) and the data signal being high (1) (V₁₀ from table 1).

FIG. 12C shows a close up on the region of the trace where the modulated first control signal 1017 is being superimposed onto the power signal and the logical states are changed: the clock and data output of the primary processor 1015 from both being high (1) (V₀₀ in table 1) to both being low (00) (V₁₁ in table 1).

The multi-frequency signal created by superimposing the modulated first control signal onto the power signal is passed through the primary coil 1009 and the secondary coil 1011 experiences an inductive influence.

On the secondary side 1005 of the system 1000, the induced signal is a combination of both the power signal and the modulated first control signal 1017, which needs to be split. Therefore, the induced signal on the secondary side 1005 passes through the interpretation module 1023 which extracts the modulated first control signal 1017 and interprets it.

The interpretation module 1023 includes an inductive transformer with an LC filer 1047. This is used for separating the modulated first control signal 1017 from the power signal and the modulated second control signal 1029.

The inductive transformer 1047 includes a first coil 1047a in series with the secondary coil 1011 of the system 1000 and a second inductive transformer 1063 (discussed below in more detail), and a second coil 1047b in series with a filter 1049a of the interpretation module 1023.

The capacitor of the LC filter 1047c is connected across the first coil 1047a of the inductive transformer 1047. As discussed above, the lower frequency signal, with frequency fₚ is the power signal, and the higher frequency signal, with frequency f_{c1} is the modulated first control signal. The LC filter is selected to isolate the frequency of the modulated first control signal 1017 from other frequencies.

The separated control signal is now passed through a band pass filter and amplifier sub-module 1049 having filter 1049a and amplifier 1049b. The filter is a first order narrow band pass filter used to isolate the carrier frequency of the modulated first control signal. Output of this submodule 1049 is a signal corresponding to the modulated first control signal 1017, having four different voltage levels.

FIG. 13 illustrates an example of the signal 1045c induced at the secondary coil 1011, which is the modulated first control signal superimposed on the primary side 1001. FIG. 13 is the output from the filter 1049a and amplifier sub-module 1049b. As shown in FIG. 12A, this includes regions 1045b′, 1045b″, 1045b′″, and 1045b″″ in which the first control signal adopts different values: 00, 01, 10 & 11 respectively.

For demodulation, the signal is then passed through a comparator sub-module 1051 having comparators for detecting the four different voltage levels. A logic sub-module 1025 having logical gates is then used to convert the voltage detected at the comparator sub-module 1051 into two separate binary logic values representing the data signal 1019a and clock signal 1019b respectively. These are fed to the secondary processor 1027 which is used to control the operation of the load (for example light emitting elements 101).

As can be seen in FIG. 13, the received signal 1017 at output of the module 1049 has 4 voltage levels including zero. The first range (Q1) 1121a refers to V₀₁, V₁₀, and V₁₁, the second range (Q2) 1121b refers to V₁₀ and V₁₁ and the third range (Q3) 1021c refers to V₁₁ according to table 1. Table 2 illustrates the demodulation step of the received signal 1017 and the two original data (SDA) 1019a and clock (SCL) 1019b signals extracted from it.

TABLE 2

| | Q1 | Q2 | Q3 | | | | |
|---|---|---|---|---|---|---|---|
| | 1^{st} range | 2^{nd} range | 3^{rd} range | S̅C̅L̅ | S̅D̅A̅ | SCL | SDA |
| V₀₀ | 0 | 0 | 0 | 0 | 0 | 1 | 1 |
| V₀₁ | 1 | 0 | 0 | 0 | 1 | 1 | 0 |
| V₁₀ | 1 | 1 | 0 | 1 | 0 | 0 | 1 |
| V₁₁ | 1 | 1 | 1 | 1 | 1 | 0 | 0 |

According to table 2:

$$SCL = \overline{Q 2}$$

$$and$$

$$SDA = \overline{Q 3} \cdot \overline{Q 1 \overline{Q 2}}$$

Where the line above each item indicates the inverse of that digital signal level.

Therefore, the logic sub-module 1025 is designed to separate the data (SDA) 1019a and clock (SCL) 1019b signals from the four-level signal.

For providing power to the load (e.g. light emitting elements 101) the induced signal may be changed back from an AC to a DC signal using a full wave rectifier 1053 followed by a capacitive filter circuit 1055. Some applications may call for AC operating voltages and so this stage can be omitted, or another inverter can be used to generate intended AC power supply. Furthermore, a voltage regulator 1057 may optionally be provided to fix the DC voltage on the secondary side to work with the light emitting elements 101 accordingly.

The modulated second control signal 1029 is generated in the secondary side of the circuit 1005. Since the secondary processor 1027 is operating as a follower, the second control signal 1029′ includes only a data component. No clock signal is provided from the secondary side 1005, since there is a common clock component transmitted from the primary side 1001. As with the primary processor 1015, the output of the secondary processor is logically inverted by a logic inverter gate 1115 to reduce power consumption of the system 1000.

As with the modulated first control signal, the modulated second control signal 1029 is generated from a digital data signal 1029′. In one example, the digital data signal 1029′ is generated by inverting the data output 1079 of the secondary processor 1027 during an acknowledge window. In a similar fashion to the primary side 1001 of the system 1000, the two data signals 1019a, 1079 are provided on a single line in the secondary side 1005.

As with the modulated first control signal 1017, the second control 1029′ should be superimposed onto the power signal at the secondary circuit side 1005 by superimposing module 1123. For this purpose, first the second control signal 1029′ is modulated onto a second carrier signal with frequency f_{c2} to generate the modulated second control signal 1029 by a modulation module 1059. In the example being discussed, Amplitude-Shift Keying Modulation (ASK) is again used, with carrier frequency of f_{c2}=8 MHz. The carrier frequency of the modulated second control signal 1029 is different to the carrier signal for the modulated first control signal 1017 to allow the separate control signals 1017, 1029 to be distinguished. The modulated carrier signal is also amplified by amplifier 1061. Other types of modulation and other values of carrier frequency are acceptable.

As with the superimposing of the modulated first control signal 1017, the modulated second control signal 1029 is superimposed onto the power signal at the secondary coil 1011 using an inductive transformer 1063 including an LC filter. A first coil 1063a of the transformer 1063 is connected in series with the amplifier 1061 for amplifying the modulated second control signal 1029. A second coil 1063b is connected in series with the secondary coil 1011 of the wireless power and data transfer system 1000 and also with the first coil 1047a of the inductive transformer used to isolate the modulated first control signal 1017. Therefore, two inductive transformers 1047, 1063 are connected in series with the secondary coil 1011 of the system 1000—one for superimposing the modulated second control signal 1029 to the power signal and another for extracting the modulated first control signal 1017 from the power signal and modulated second control signal at the secondary side circuit 1005.

The LC filter 1063c of the second inductive transformer on the secondary side 1005 is formed by the second coil 1063b of the inductive transformer 1063 and a capacitor connected across the second coil 1063b of the transformer 1063. This filter is a bandpass filter centred on the carrier frequency of the modulated second control signal (f_{c2}) to remove the frequency of the power signal fₚ and the modulated first control signal f_{c1}.

The second inductive transformer 1063 on the secondary side 1005 allows the modulated second control signal 1029 to be superimposed on top of the power signal at the secondary side circuit 1005. This superimposed signal is induced to the primary coil 1009 and can be interpreted at the primary side circuit 1001.

The second inductive transformer 1063 on the secondary side 1005 is selected to provide a significant difference between f_{c2} and fₚ in order to minimize the interferences and allow for easier separation of signal into constituent components on the secondary side.

FIG. 14A illustrates an example of a signal 1065 at the secondary coil 1011. The signal 1065 includes a first region 1065a in which there is only the power signal, second regions 1065b in which the modulated first control signal 1017 is superimposed and third regions 1065c which shows the power signal together with both modulated first and second control signals 1017, 1029 superimposed. FIG. 14B shows a close up of a region 1065c including both modulated control signals 1017, 1029 superimposed.

In a similar manner to the isolation of the modulated first control signal on the secondary side 1005 of the system 1000, the primary side 1001 of the system 1000 includes a second inductive transformer with LC filter 1067 in order to isolate the modulated second control signal from the power signal and modulated first control signal on the primary side 1001.

The second inductive transformer 1067 on the primary side 1001 includes a first coil 1067a in series with the primary coil 1009 of the system 1000. This is also in series with the second coil 1043b of the first inductive transformer 1043 on the primary side 1001, used for superimposing the modulated first control signal 1017 onto the power signal on the primary side 1001.

The second inductive transformer 1067 on the primary side 1001 includes a second coil 1067b in series with an interpretation module 1071 used to analyze and interpret the modulated second control signal 1029.

The capacitor of the LC filter 1067c is connected across the first coil 1067a of the inductive transformer 1067. The LC filter is selected to isolate the frequency of the modulated second control signal 1029 from the power signal and modulated first control signal 1017.

The separated second control signal is now passed through a band pass filter and amplifier sub-module 1071 having filter 1071a and amplifiers 1071b. The filter is a first order narrow band pass filter used to isolate the carrier frequency of the modulated second control signal. Output of this sub-module 1071 is a signal corresponding to the modulated second control signal 1029.

The signal is then passed through a comparator sub-module 1073. In the current example, since the modulated second control signal 1029 includes a data portion only, the data signal is a binary signal having only a high or low value. Thus, only a single comparator is required for demodulation of the signal. The determined high (1) or low (0) value is fed to the primary processor 1015. As shown in FIG. 10A, a single line is provided for the two control signals 1019a, 1079 on the primary side 1001 of the system 1000. As the second control signal 1029′ is inverted on the secondary side 1005, the comparator should be designed to invert the binary data channel before feeding it into the data signal 1019a. Therefore, as mentioned above, there is no need to use a logic inverter gate on the primary side 1001 for this purpose.

Any type of bidirectional communications may be achieved using the above system. For example, the above system has two channels on one side and one channel on the other side, but there may be two or more channels on both sides.

In one case, that will now be discussed in detail by way of example only, the first control signal 1035 may comprise commands for controlling the operation of the light emitting elements 101, and the second control signal 1029′ may comprise an acknowledge signal.

In a leader/follower relationship, the follower processor (secondary processor 1027) may need to send an acknowledge signal to leader processor (primary processor 1015) after correctly receiving each 8 bits to confirm successful instruction delivery.

The acknowledge signal should be transmitted in the correct timing window (real time bidirectional data communication) and is treated in the same manner as the second control signal 1029′ discussed above (i.e., modulated onto a carrier frequency f_{c2}).

FIG. 15 illustrates a communication window for sending two bytes 1089a, 1089b of data from the primary processor 1015 to the secondary processor 1027 using the I2C communications protocol. FIG. 15 shows the data output 1019a and clock output 1019b from the primary processor 1015 and the data output 1079 from the secondary processor 1027 before inversion and digital signal 1029′ used to generate the second control signal (which is generated by inversion of the data output 1079 of the secondary processor 1027). For the sake of illustration, any effects from inverting the primary processor data signal 1019a or clock signal 1019b are removed.

Within the I2C protocol:
The start of the communication sequence 1091 is indicated by the clock signal 1019b being in high (1) state (or low state after inversion), and the data signal 1019a from the primary processor 1015 (transmitting device) falling from high to low (1 to 0) edge (or rising from low to high state after inversion).
The stop of the communication sequence 1093 is indicated by the clock signal 1019b being in a high state (or low state after inversion), and the data signal 1019a rising from low to high (0 to 1) edge (or falling from high to low state after inversion).

Between the start and stop points, an unlimited number of bytes of data can be transmitted. Each bit of the byte is transmitted by the data output 1019a of the primary processor 1015. Any change in data state from high to low or low to high can only take place when the clock signal is low (0) (or high after inversion). The value of each bit is the value of the data output 1019a when the clock is in the high state (or low after inversion).
After each transmitted byte, there is an acknowledge window 1095a and acknowledge signal 1079 which is transmitted by the secondary processor 1027 during the acknowledge window 1095a. The acknowledge signal is transmitted as the data output 1079 of the secondary processor 1027 during the acknowledge window 1095b. To do this, the data output 1079 of the secondary processor 1027 is pulled down (to low state) while the data component 1019a from the primary processor 1015 is left high.

When the 8^{th} bit of each byte has been received, the clock signal 1019b turns to low state (high after inversion) and the data output 1079 from the secondary processor changes from high to low (start of the acknowledge pulse). On the next low state of the clock signal 1019b, the data output 1079 from the secondary processor 1027 changes back to high state as the end of the acknowledge pulse. This acknowledge pulse takes place within a fixed period of the clock signal 1019b, for example within 10 μs. This fixed time period forms the acknowledge window. Therefore, for each byte of data, the system implements a 9-bit cycle—8 bits data followed by one bit acknowledge.

If this acknowledge pulse (changing from high to low and changing back from low to high within the acknowledge window) is mistimed, either the data output 1079 from the secondary processor 1027 going from low to high or from high to low may occur when the clock signal 1019b is in the high state (i.e., outside of the acknowledge window), communication between the primary and secondary sides will fail. In this case the microcontroller interprets this mistiming as either start of communication or stop of communication and so causing the program to crash.

To correctly detect the acknowledge window, three counters 1077a, 1077b, 1077c may be implemented in a detection module 1075 which monitors the data signal 1019a transmitted by the first processor 1015, and the data output 1079 from the secondary processor 1027. The counters detect the acknowledge window, and if the correct output from the secondary processor 1027 is received, generates an output to transmit back to the primary processor 1015. The correct output from the secondary processor 1027 is a low pulse during the acknowledge window which indicates that the secondary processor 1027 has received a byte of instructions correctly. FIG. 17 illustrates the arrangement of the counters 1077a, 1077b, 1077c in more detail.

Each counter is implemented as a logic device which can have an output that is low or high. Each counter 1077a, 1077b, 1077c has a first input (C̅L̅K̅) and a second input (MR), and four outputs nQ0 to nQ3 (where n is the counter number). Each counter follows the same truth table shown in table 3 below:

TABLE 3

| First | Second | Output |
|---|---|---|
| input (C̅L̅K̅) | input (MR) | state |
| 1 | 0 | No change |
| Falling from | 0 | Increment |
| 1 to 0 | | counter |
| Rising from | 0 | No change |
| 0 to 1 | | |
| 0 | 0 | No change |
| X | 1 | Outputs Q0 to |
| | | Q3 to 0 |

For each counter, the total counted is indicated by the value of the four outputs as indicated in table:

TABLE 4

| Total | | | | |
|---|---|---|---|---|
| counted | Q0 | Q1 | Q2 | Q3 |
| 0 | 0 | 0 | 0 | 0 |
| 1 | 1 | 0 | 0 | 0 |
| 2 | 0 | 1 | 0 | 0 |
| 3 | 1 | 1 | 0 | 0 |
| 4 | 0 | 0 | 1 | 0 |
| 5 | 1 | 0 | 1 | 0 |
| 6 | 0 | 1 | 1 | 0 |
| 7 | 1 | 1 | 1 | 0 |
| 8 | 0 | 0 | 0 | 1 |
| 9 | 1 | 0 | 0 | 1 |

The first counter 1077a detects the start of a communication window by monitoring the data signal 1019a and clock signal 1019b received from the primary processor 1015 received at the secondary side 1005. The data signal 1019a is connected to a first input (C̅L̅K̅) 1097a of the first counter 1077a and the clock signal 1019b is connected to a second input 1097b (MR), through a logic inverter gate 1099. Therefore, when, the clock signal 1019b is high and the second input 1097b of the first counter 1077a is low due to the logic inverter gate 1099, and the data signal 1019a is falling from high to low, the first counter increments by 1 according to table 3. This causes the first output (1Q0) 1109 of the first counter 1077a to change to high, as in table 4, and indicates the start of the communication window.

FIG. 15 shows the output 1109 of the first counter 1077a. The first output 1109 of the first counter 1077a is connected to the second input 1101b (MR) of the second counter 1077b. As indicated in table 3, when the second input 1101b is high, all outputs of the second counter 1077b are reset to 0, effectively resetting the second counter 1077b.

The first input (C̅L̅K̅) 1101a of the second counter 1077b is connected to the clock signal 1019b. On the next change of the clock signal 1019b, the first counter will reset until the next start of a communications window is detected. This will cause the first output (1Q0) 1109 to return to low. Therefore, according to table 3, each change of the subsequent changes in the clock (including the one that causes the first counter 1077a to reset) will cause an increment in the second counter 1077b, changing the outputs according to table 4.

FIG. 15 shows the first output (2Q0) 1111a, second output (2Q1) 1111c, third output (2Q2) 1111d and fourth output (2Q3) 1111b of the second counter 1077b. Furthermore, at the top of FIG. 15, the total count from the second counter 1077b is shown.

The first output (2Q0) 1111a and fourth output (2Q3) 1111b of the second counter 1077b are connected to an AND gate 1103. Thus, when both 2Q0 and 2Q3 are high (which only occurs once the counter reaches 9) the output of the AND gate 1103 switches to high.

The output of the AND gate 1103 is coupled to the second input 1101b of the second counter 1077b. Thus, according to table 3, when the output of the AND gate 1103 switches to high when the second counter reaches 9, then all outputs of the second counter 1077b are reset to 0.

The output of the AND gate 1103, and the first output (1Q0) 1109 of the first counter 1077a are connected to the second input 1101b of the second counter by an OR gate 1105. Thus, either condition (detecting the start of a window or the second counter reaching 9) causes a reset at all outputs of the second counter 1077b.

The first input (C̅L̅K̅) 1107a of the third counter 1077c is connected to the fourth output (2Q3) 1111b of the second counter 1077b and the second input (MR) 1107b of the third counter 1077c is connected to the first output (2Q0) 1111a of the second counter 1077b.

On receipt of the 9^{th} bit (the acknowledgement bit), the first and fourth outputs 1111a, 1111b of the second counter 1077b are changed to high. As discussed above, this causes a reset in all outputs of the second counter 1077b. Therefore, the first output (2Q0) 1111a of the second counter 1077b which is connected to the second input (MR) 1107b of the third counter 1077c stays low and the fourth output (2Q3) 1111b of the second counter 1077b which is connected to the first input (C̅L̅K̅) 1107a of the third counter 1077c falls from high to low. According to table 3, this causes an increment in output of the third counter 1077c. It means the first output (3Q0) 1113 of the third counter 1077c will have stayed high until starting 1^{st} bit of the next cycle because by rising in the first input (2Q0) 1111a of the second counter 1077b all outputs of the third counter 1077c will be reset to 0. As discussed above, the acknowledge window is a period of time when the high output 1113 of the third counter 1077c is detected.

The inversion of the data output 1079 of the secondary processor 1027 is monitored during this acknowledge window. For this purpose, the first output (3Q0) 1113 of the third counter 1077c is connected to a first input of another AND gate 1117 (see FIG. 10B). The second input of the AND gate 1117 is connected to the logic inverter gate 1115 on the data output 1079 of the secondary processor 1027.

The default data output signal 1079 of the secondary processor 1027 is a high state (1), which is inverted to a low state (0) by the logic inverter gate 1115. When the acknowledge signal is sent, the data output signal 1079 changes to a low state (0), which is inverted to a high state (1) by the logic inverter gate 1115. This inversion reduces the power consumption of the system 1000, as there is no need to send a permanent high from the secondary to the primary except during the periods in which acknowledge is detected.

Therefore, when the acknowledge signal is sent by the secondary processor 1027, both inputs to the AND gate 1117 are high, which changes the output of the AND gate to a high state (1) which is transmitted as the digital signal 1029′ used to generate the modulated second data control signal 1029. Thus, it may be considered that when the first output (3Q0) 1113 of the third counter 1077c is high, this indicates the window for receiving the acknowledge signal and the detection module 1075 is able to detect the acknowledge signal, indicating the successful receipt of the previous byte of data.

In the above example, the secondary side of the system 1005 is mounted on the support 17, and thus the secondary side of the system 1005, including the coil 1011 may rotate, in use.

In other examples, the coils 1009, 1011 may be stationary. However, it will be appreciated that in some cases, one or both of the coils 1009, 1011 may be rotated about an axis extending perpendicular to the plane in the which the coils 1009, 1011 are formed. Rotation may also be around any other suitable axis, provided the coils 1009, 1011 maintain sufficient air or vacuum gap to allow inductive transfer of signals.

The primary side circuit 1001 and secondary side circuit 1005 may be implemented in any suitable way. In one embodiment, at least part of the primary circuit 1001 may be formed on a printed circuit board (PCB) (not shown) with surface mount components. Connections between the components may be via conducting traces, wires, or other type of connections. Further intervening components for other treatment of the signals may also be included.

Similarly, the secondary circuit 1005 may also be formed on a PCB in the same manner.

All of the primary circuit 1001 may be formed on a single PCB or may be distributed across multiple PCBs. Likewise, all of the secondary circuit 1005 may be formed on a single PCB or distributed across multiple PCBs. Some components may be formed separately and mounted independent from the PCB. For example, the coils 1009, 1011 may be formed away from the PCB(s).

The use of the PCB is by way of example only. The circuits 1001, 1005 may be formed and mounted in any suitable way.

FIGS. 16A, and 16B illustrate example embodiments of the coils 1009, 1011, in cut-through side view and 3D view. By way of example, the devices 1 discussed in FIGS. 1 to 7 make use of the coils shown in FIGS. 16A and 16B.

Each coil 1009, 1011 is formed by a wire 1081 wound around a central axis 1087. In the example shown, the coils 1009, 1011 are planar, in a plane perpendicular to the central axis 1087. However, this is by way of example only. The coils may also be of any shape when viewed end on, such as circular, elliptical, square or the like.

In some examples, a single wire 1081 forms each coil, but in other examples, multiple wires 1081 may be used. The wire 1081 in the primary and secondary coils 1009, 1011 will be made of any suitable conductive material for wireless power and data transfer and may be of any suitable gauge. The coils may have any suitable number of windings, with any suitable density of windings.

In a first example, shown in FIG. 16A, the coils 1009, 1011 may be continuous from the central axis 1087 to the outer perimeter. In a second example, shown in FIGS. 16B, the coils may be annular, with a central aperture 1083 formed along the central axis 1087. It is also possible to use coils of different type (winding, size, etc) for either primary or secondary sides.

Optionally, in order to improve the inductive transfer between the coils 1009, 1011, a cylindrical ferrite core of suitable ferrite material 1085 may extend through the aperture 1083, between the two coils 1009, 1011. The ferrite core 1085 has a central axis 1087 extending along a direction perpendicular to the coils 1009, 1011, and passes through the aperture 1083 formed in both coils 1009, 1011. The ferrite core 1085 may be hollow with closed ends, hollow with open ends (to allow passage of other components) or solid.

As discussed above, the coils 1009, 1011 may be annular, with a central aperture formed along the axis 1087, and a cylindrical core 1085 extending through the aperture 1083, between the two coils 1009, 1011. Optionally, the core may be ferrite to improve the inductive transfer between the coils 1009, 1011

In the example shown, the support is frustoconical in shape. However, this is by way of example only. The support may have any shape which widens towards the distal end 11 of the device. For example, instead of following a straight line in cross section, the support may follow a curve or another shape. The cone may also not be circular in cross-section perpendicular to the axis. For example, the cone may be frustopyramidal or frustocuboidal.

In yet further examples, the support may be a flat disc arranged perpendicular to the axial direction. In this case, the surface of the disc facing forwards towards the patient corresponds to the inner surface 19 (the forward facing surface) of the frustoconical support, and the opposing surface corresponds to the outer surface 21 (rear facing surface). It will be appreciated that, when viewed from the front. The arrangement of light emitting elements will be the same as for the frustoconical support.

The housing 5 may be made of any suitable material such as plastics. Likewise, the internal support structure 61 and other internal components can be made of any suitable material.

The support 17 may be plastics or any other material.

In some examples, the support 17 and/or the PCB may comprise electrically connecting vias or conduits, extending through the support 17 or PCB to allow connectivity between the inner surface 19 and outer surface 21.

The housing may be made in two or more parts to allow the internal components to be assembled, and the housing 5 assembled around them. The components may be joined by screws, snap fit projections glue or adhesive, or any other suitable components.

The support assembly 33 and stationary assembly 73 are by way of example only. Any suitable structures may be provided to mount the support 17 and drive rotation, and any suitable structure may be provided to support stationary components.

In the examples discussed above, the camera 79 and lens 81 are provided at the proximal end 25 of the support 17 as this provides best placement for capturing images. However, the camera and lens may be spaced from the support along the axis. Furthermore at least the camera 79 may be off the axis, connected by optical fibers or provided with a prism or mirror assembly. By using a beam splitter, this may allow for the concurrent use of a viewing window for the operator and a camera.

In some embodiments, the core 1085 is used to support the stationary components is made of a ferrite material to improve wireless power transfer. However, this is by way of example only, and the core 1085 may simply be structural. Alternatively, the core 1085 may be omitted.

Any suitable means can be used to link the output of the motor 57 to the support 17. For example, a belt, chain or cogs may be used to transfer rotation. There may be gearing to step the output of the motor up or down, or the support 17 may be driven at the same speed as the motor.

The shape of the device 1 is by way of example only, and the device may have any suitable handheld shape.

Any suitable means can be used to attach accessories in front of the support 17.

In the description discussed above, a number of examples of sets of light emitting elements are provided. These are given by way of example only. The light emitting elements may be arranged in any way. Light emitting elements within a set may be arranged in a string following any path on the internal surface 19 of the support 17.

In the examples given above, the light emitting elements 101 arranged in strings (either linear or arcs) are evenly spaced. However, this is by way of example only. The spacing between light emitting elements 101 may be varied. In one example, the spacing may be increased towards the distal end of the support 17, to ensure an even projection on the eye. However, other variations in spacing may also be provided.

The internal surface 19 of the support may be provided with any one or more of the sets discussed above, or any other sets. Any combination of the sets may be provided.

In some examples, one or more sets of light emitting elements 101 may be mounted on a PCB arranged axially behind the support. This may be the annular PCBs 63a, 63b discussed above, or separate PCBs that may be flexible or rigid. The support 17 will include openings or apertures aligned with light emitting elements 101. The PCB on which the light emitting elements 101 are mounted is fixed such that it rotates with the support 17. Thus, the light emitting elements 101 are still considered to be mounted on the support 17, and rotate in the same way as light emitting elements 101 mounted on the inner surface 19 of the support 17. Mounting light emitting elements in this way allows for a greater number of elements to be fitted in a limited space.

In one example. the light emitting elements 101 for the slit lamp projection may be mounted behind the support. However, this is by way of example only, and any of the sets discussed above may be mounted in this way.

Any suitable control circuitry may be used to switch the light emitting elements on and off.

Use of a PCX lens to shape the output of a single light emitting element or an array of light emitting elements is by way of example only. Any suitable shaping lens 110 may be used to create any suitable shape.

The light emitting elements may be switched in any way, and the support may be rotated in any way such that a wide range of techniques can be used. The measurements discussed above are by way of example only, and other measurements will be apparent to the person skilled in the art.

Any suitable processor or microprocessor may be used as the primary processor 1015 and secondary processor 1027. For example, the primary processor may be a processor from a Raspberry Pi, or any other suitable type of processor. The primary processor 1015 and the secondary processor 1027 may be a LED Driver, motor diver, sensor, or any type of microprocessors or microcontrollers.

The secondary circuit 1005 may directly power the light emitting elements 101. Alternatively, a battery or capacitor may be provided to store power received. There may also be a combination of direct supply when required, with a battery arranged to store power when direct power is not required.

In the system discussed above, the following frequencies are used:
The frequency of the data signal 1019a from the first processor 1015
The frequency of the data signal 1079 from the second processor 1027
The frequency f_{d} of the clock signal 1019b.
The frequency fₚ of the power signal.
The frequency f_{c1} of the carrier signal for the modulated first control signal 1017.
The frequency f_{c2} of the carrier signal for the modulated second control signal 1029.

The frequencies and ranges discussed above, are given by way of example only. In order to allow the modulated first and second control signals 1017, 1029 to be discerned over one pair of coils, the carrier signals should have different frequencies to each other and to the power signal.

In order to achieve efficient power transfer, the power signal may be the lowest frequency and highest amplitude out of the power signal and the two carrier signals.

In order to improve detectability of the modulated control signals, the frequency of the carrier signals may be one or more orders of magnitude higher than the power signal frequency. Furthermore, the frequency of the carrier signals may be several times the frequency of the data signal (and clock signal) output from the processors 1015, 1027.

In the example discussed above, the frequency f_{c2} of the carrier signal for the modulated second control signal 1029 is the highest frequency, but this is by way of example only. The amplitude of the two carrier signals may be the same or may be different to improve detectability. For example, the highest frequency signal may have the lowest amplitude.

In the example discussed above, the primary processor 1015 acts as a leader and the secondary processor 1027 acts as a follower. This means that the secondary processor 1027 is synchronized to the primary processor's clock signal 1019b. However, this is by way of example only. In some cases, the secondary processor 1027 may act as the leader. In this case, the secondary side 1005 of the system 1000 may include the combination module 1021 to combine the data signal and clock signal. In some cases, both sides may include a combination module 1021 to allow either side to be selected as the leader and send more than one data channel.

The power source 1003 may include an AC power supply, in which case the power inverter 1041 is not required.

In the example discussed above, the output of the primary processor 1015 and secondary processor 1027 are logically inverted. This is by way of example only for reducing power consumption of the system 1000. The output of one or both of the processors 1015, 1027 may not be inverted in some embodiments.

The interpretation modules 1023, 1069 discussed above are by way of example only. Any suitable way to separate and analyze the modulated control signals 1017, 1029 from the power signals may be used.

In the examples discussed above, the binary values of the data signal 1019a and clock signal 1019b are combined into a single signal with four different voltage levels. Any suitable method can be used to combine the signals, for example, for different current values, or four different frequency values may be used. In addition, sending more than two data channels is possible. For example, sending 3 data channels combined into a single signal with 8 different voltage levels

Furthermore, any suitable modulation scheme may be used to modulate the carrier frequencies with the data information on both the primary and secondary side.

The counter discussed is given by way of example only. Any suitable counters or any other type of logic gates may be used for timing of communications.

In the above example, communication under the I2C protocol has been discussed. However, any suitable communication protocol can be used. In some communication protocols, synchronization of the processors 1015, 1027 may not be required. In this case, there may be no need to combine a data signal 1019a and clock signal 1019b at the leader side of the system 1000. Counters may not be necessary in other communication protocols and they may be replaced with alternative solutions.

It will be appreciated that various parameters of the system, such as the frequencies discussed above, the number of turns in the coils 1009, 1011, the power source 1003, the presence (or not) of the rectifier 1053 and voltage regulator 1057 on the secondary side 1005 and the voltage provided by the regulator 1057 and any other circuit components can be tuned to achieve any desired power at the light emitting elements 101, based on end user requirements.

The wireless power and data transfer system 1000 discussed above may be used in permanently installed, fixed applications to provide power transfer and data communications between stationary and rotary parts. For example, as shown in FIGS. 18A, 18B and 18C, the wireless power and data transfer system 1000 may be used in wind turbines 1300. FIGS. 18A and 18B show the wind turbine 1300 in front and side view respectively. FIG. 18C shows the working mechanisms of the wind turbine 1300 in more detail, in a schematic sectional side view.

A wind turbine 1300 has a rotor 1302 comprising a hub 1304 and blades 1306a-c mounted from a fixed body 1308. In use, the action of the wind drives the rotor 1302 to rotate, which drives a generator 1310 in the body 1308 through shaft 1312. The body 1308 remains stationary.

The hub 1304 includes mechanisms 1314a-c dedicated for adjusting the angle of the wind turbine blades 1306a-c and various sensos 1316. A controller 1318 is also provided to communicate with a main control unit 1320 on the body 1308, and to control the mechanisms 1314a-c, and sensors 1316. The mechanisms 1314a-c, sensors 1316 and controller 1318 form part of a rotor control system.

Drive is provided from the rotor 1304 to the generator 1310 using the shaft 1312 in a manner that is known to a person skilled in the art. Typically slip rings are used to provide power to the mechanisms 1314a-c and sensors 1316, and to provide data communications between the controller 1318, 1320 (both providing controls to the mechanisms 1314a-c and feedback data from the sensors 1316). However, the continuous wireless power and data transfer system 1000 discussed above can be used in wind turbines 1300 as an alternative to slip rings.

It will be appreciated that the wind turbine 1300 discussed above is schematic only, and any suitable type of wind turbine 1300 can be used. Furthermore, various other applications which can employ the continuous wireless power and data transfer system 1000 discussed above can be used will also be apparent. For example, the system 1000 can be used in any application where slip rings and any other wireless power transfer and/or wireless data transfer is required.

Another type of application for the wireless power and data transfer system 1000 may be in releasable connectors between components, equipment or separate electrical devices (in other words a plug and socket type arrangement). In this application, the primary and secondary coils 1009, 1011 are not installed permanently in a system but instead are held in an enclosure 1200 of plastic, rubber or other suitable protective materials, as shown in FIGS. 19A to 19F.

In one example, only the coils 1009, 1011 are provided in the enclosures. The coils 1009, 1011 and are connected to the control PCBs by means of wires 1201 that lead to each coil enclosure 1200. FIGS. 19A and B shows a single coil arranged in this way. FIGS. 19C, 19D and 19E show pairs of coils 1009, 1011 in enclosures 1200 together. The coil enclosures 1200 of the two coils 1009, 1011 may engage and/or locate together in any suitable way to hold the coils together.

In a first example, shown in FIG. 19B, a central aperture 1204 may be provided for securing the two enclosures together by a nut and bolt (not shown). In this example, the nut may be made of a ferrous material, to act as a core as discussed above. In another, as shown in FIG. 19C, magnets 1205 located around the internal perimeter or the centre of the coil enclosure 1200 may be used to secure the coils together. In further examples, shown in FIG. 19D, one of the enclosures 1200 may be provided with a locating pin or projection 1202 and the other enclosure with a corresponding recess 1203 to receive the pin 1202. Alternatively, coils may also be held together by means of a clamping mechanism 1207, as shown in FIG. 19E or by means of a screw mating interface 1208 where one coil enclosure is screwed into the opposing coil.

In another example, the cylindrical core 1085 discussed above, which may be hollow or solid, may be integrated as part of one of the enclosures, 1200, and used as a connector between the two enclosures.

It will be appreciated that or any other suitable method that ensures the correct alignment and spacing between coils may be used. Furthermore, any combination of the methods shown in FIGS. 19A-F and any other method may be used. Magnets 1205, pins and recesses 1202, 1203, through holes 1204 for bolts and other formations may be provided in any suitable position on the enclosures 1200.

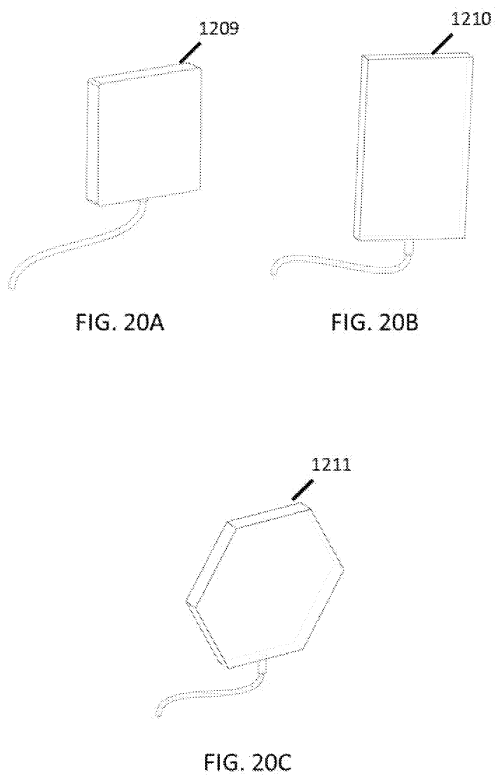

The coil enclosures 1200 may be of a circular, square, rectangular or other shape that matches the coil spacing & mating requirements of the application in which the connector is used. FIGS. 19A-F all show round enclosures 1200. However, FIGS. 20A to C show enclosures 1209, 1210, 1211 that a square, rectangular and hexagonal. These are shown by way of example only, and any suitable shape may be used.

In the examples of connectors discussed above, both coils 1009, 1011 are located remotely from the PCB control circuitry, and connected by wires 1201. In other examples, one or both of the primary side 1001 and secondary side 1005 may have the control circuity located at the same place as the coils 1009, 1011. Therefore, one of the enclosures 1200 may be fixed as part of a larger unit or body, and the other enclosure 1200 may be free or floating on the end of a wire 1201. The primary coil 1009 may be installed or fixed, and the secondary coil 1011 may be floating, or vice versa. Alternatively, as shown in FIGS. 19D-F, both enclosures may be free or floating.

The continuous wireless power and real time bidirectional data transfer system can be used in commercial, industrial and military connectors, connectors in space applications including satellites and ships, marine and waterproof applications, and wireless charging and communications applications.

In the illumination devices discussed above, the use of inductive wireless power and data transfer is by way of example only. Any suitable power and data transfer techniques can be used. For example, near field wireless power transfer may take place by inductive coupling or capacitive coupling. For example, slip rings and commutators, infrared or radio frequency, electrical transfer across bearing surfaces.

Alternatively, the support may act as the rotor of the motor. Conducting coils may be placed around the circumference of the support. The support is then held in a shroud or cover which is lined with permanent magnets that surround these coils but leave a small gap which prevent both from touching. As the support 17 is rotated the magnets induce current flow in the coils which power the support 17 and corresponding components.

Communications between the components mounted on the support 17 and the control circuitry 89 may be carried out using the wireless power transfer signal. This may be as discussed above, or via techniques such as Radio Frequency Identification (RFID) and Near Field Communications (NFC). Alternatively, separate wireless power communication may be provided. This may be, for example, using Wi-Fi, Bluetooth, cellular communications, Zigbee or other wireless power transfer communications.

1. A wireless power and data transfer system comprising:
a single pair of inductive coils including:
a primary coil arranged to transmit a power signal having a first frequency; and
a secondary coil arranged to receive the power signal from the primary coil by wireless induction;
a primary side circuit arranged to: generate a modulated first control signal by modulating a first control signal on a first carrier signal; and superimpose the modulated first control signal onto the power signal at the primary coil, the first carrier signal having a second frequency different to the first frequency; and
a secondary side circuit arranged to: generate a modulated second control signal by modulating a second control signal on a second carrier signal; and superimpose the modulated second control signal onto the power signal at the secondary coil, the second carrier signal having a third frequency different to the first frequency and second frequency.

2. A wireless power and data transfer system as claimed in claim 1, wherein:
the primary side circuit comprises a primary filter arranged to isolate the modulated second control signal from the power signal and the modulated first control signal at the primary coil; and
the secondary side circuit comprises a secondary filter arranged to separate the modulated first control signal from the power signal and the modulated second control signal at the secondary coil.

3. (canceled)

4. A wireless power and data transfer system as claimed in claim 1, wherein each of the first control signal and the second control signal includes at least one data channel for transferring data between the primary side circuit and the secondary side circuit.

5. A wireless power and data transfer system as claimed in claim 4, wherein at least one of the first control signal and the second control signal includes two or more data channels.

6. A wireless power and data transfer system as claimed in claim 5, wherein the two or more data channels are combined into a control signal, prior to being superimposed on the power signal.

7. A wireless power and data transfer system as claimed in claim 5, wherein one of the first control signal and the second control signal encodes a clock component and a data component on separate channels, and the other of the first control signal and the second control signal encodes a different data component.

8. A wireless power and data transfer system as claimed in claim 7, wherein the control signal that encodes a clock component comprises a logic signal able to adopt a plurality of different logic values, each logic value corresponding to a unique combination of the values of the data component and the clock component.

9. A wireless power and data transfer system as claimed in claim 7, wherein the data component and the clock component each comprise a binary logic signal having a low value and a high value, and the control signal that encodes a clock component and a data component adopts one of four possible logic values derived from the logic value of the data component and the clock component.

10. A wireless power and data transfer system as claimed claim 7, comprising:
a combination module arranged to combine the clock component and data component into a single signal.

11. A wireless power and data transfer system as claimed in claim 1, wherein:
the primary side circuit comprises a primary modulation module arranged to modulate the first control signal to generate the modulated first control signal; and
the secondary side circuit comprises a second modulation module arranged to modulate the second control signal to generate the modulated second control signal.

12. A wireless power and data transfer system as claimed claim 1, wherein the first frequency is lower than the second frequency and the third frequency.

13. A wireless power and data transfer system as claimed in claim 12, wherein the amplitude of the power signal is greater than the amplitude of the modulated first control signal and the modulated second control signal.

14. A wireless power and data transfer system as claimed in claim 1, wherein:
the primary side circuit comprises a primary inductive transformer to superimpose the modulated first control signal onto the power signal at the primary side; and
the secondary side circuit comprises a secondary inductive transformer to superimpose the modulated second control signal onto the power signal at the secondary side.

15. A wireless power and data transfer system as claimed in claim 1, wherein:
the primary side circuit comprises a primary processor arranged to generate the first control signal and receive the second control signal; and
the secondary side circuit comprises a secondary processor arranged to generate the second control signal and receive the first control signal, wherein the first control signal comprises instructions sent from the primary processor to the secondary processor, and the second control signal comprises instructions sent from the secondary processor to the primary processor.

16. (canceled)

17. A wireless power and data transfer system as claimed in claim 15, comprising:
a first counter arranged to detect a start of a communication window, the communication window being a fixed number of bits, n, in size;
a second counter arranged to count the number of bits received from the start of the communication window or continuing counting on from the previous n-bit window, up to the fixed number of bits; and
a third counter arranged to detect the window for an acknowledge signal.

18. (canceled)

19. A wireless power and data transfer system as claimed in claim 1, wherein one or both of the primary coil and secondary coil is arranged to rotate about its central axis.

20. A wireless power and data transfer system as claimed in claim 1, wherein the primary coil and secondary coil each comprise an aperture arranged in the coil and a core extending through the opening between the primary coil and the secondary coil.

21. (canceled)

22. A wireless power and data transfer system as claimed in claim 20, wherein the core is hollow, thereby allowing components or cabling to be passed through the centre of the coils.

23. (canceled)

24. A method of wireless power and data transfer over a single pair of inductive coils, the method, comprising:
transmitting a power signal from a primary coil on a primary side to a secondary coil on a secondary side by wireless induction;
generating a modulated first control signal by modulating a first control signal on a first carrier signal;
generating a modulated second control signal by modulating a second control signal on a second carrier signal;
superimposing the modulated first control signal onto the power signal at the primary coil; and
superimposing the modulated second control signal onto the power signal at the secondary coil,
wherein the power signal has a first frequency, the first carrier signal has a second frequency different to the first frequency and the second carrier signal has a third frequency different to the first frequency and the second frequency.

25. An electrical connector having an enclosure housing:
a primary coil arranged to transmit a power signal having a first frequency; and
a primary side circuit arranged to:
generate a modulated first control signal by modulating a first control signal on a first carrier signal;
superimpose the modulated first control signal onto the power signal at the primary coil, the first carrier signal having a second frequency different to the first frequency; and
filter a modulated second control signal superimposed on the power signal by a secondary coil coupled to the primary coil, the modulated second control signal formed by modulating a second control signal on a second carrier signal, the second carrier signal having a third frequency different to the first frequency and second frequency,
wherein the electrical connector is releasably connectable to a device including the secondary coil.

26-102. (canceled)
